(19) United States
(12) Patent Application Publication
(10) Pub. No.: US 2013/0203506 A1
(43) Pub. Date: Aug. 8, 2013

(54) SOCIAL NETWORKS GAMES CONFIGURED TO ELICIT MARKET RESEARCH DATA AS PART OF GAME PLAY

(71) Applicant: Disney Enterprises, Inc., Burbank, CA (US)

(72) Inventors: Amber R.A. BROWN, Glendale, CA (US); Joseph W. MARKS, Glendale, CA (US)

(73) Assignee: DISNEY ENTERPRISES, INC., Burbank, CA (US)

(21) Appl. No.: 13/835,016

(22) Filed: Mar. 15, 2013

Related U.S. Application Data
(63) Continuation-in-part of application No. 13/204,500, filed on Aug. 5, 2011.
(60) Provisional application No. 61/714,688, filed on Oct. 16, 2012.

(51) Int. Cl. G06Q 30/02

(52) U.S. Cl. CPC G06Q 30/0203
USPC 463/42

(57) ABSTRACT

Techniques are described for conducting market research via interactive game play mechanics. A game platform may allow a market research sponsor to create and publish online games which can identify latent consumer sentiment (and other market research data), while simultaneously providing an entertaining and engaging experience for the game participants. The games may be tailored such that elements of game play elicit responses from participants that reveal the desired market research data, e.g., consumer product awareness, consumer sentiment, brand preferences, loyalty, trends in awareness and sentiment, etc. Providing an engaging online experience provides an element of situational distraction, leading to more authentic responses from the participants as well as greater participation rates.

### CROSS-REFERENCE TO RELATED APPLICATIONS

This application claims priority to provisional patent application Ser. No. 61/714,688, filed Oct. 16, 2012, and is a continuation in part of co-pending U.S. patent application Ser. No. 13/204,500, filed Aug. 5, 2011. The aforementioned patent applications are incorporated by reference in their entirety.

### TECHNICAL FIELD

Embodiments presented in this disclosure generally relate to techniques for gathering market research data. More specifically, embodiments presented herein relate to techniques for conducting market research using social network games.

### BACKGROUND

Businesses frequently engage in market research to evaluate a variety of business interests, such as consumer product awareness, consumer sentiment, brand preferences, loyalty, trends in awareness and sentiment, etc. For example, businesses often send surveys to groups of customers (selected randomly, or according to some demographic profile). Such surveys can be sent via the mail, but more and more such surveys are presented to users engaging in online transactions. For example, a user purchasing items online may be asked to participate in a survey to provide feedback regarding the online process as well as asked to answer other questions regarding consumer sentiment. Other approaches for conducting market research include telephone surveys as well as recruiting individuals to participate in a focus group.

However, surveys are an awkward, and frequently expensive, way of acquiring market research data, which often produces poor results. For example, producing a statistically valid result requires a large number of responses (1000-2000 or more), and vendors often charge a variable rate based on sample size, making large (better) samples prohibitively expensive in many cases. Further, a large consumer survey is difficult to deploy quickly and slow to generate results.

Further still, consumer surveys and focus groups often fail to provide an accurate measure of consumer opinion regarding fashions, trends, movies, celebrities, politics and societal and economic issues in general. For example, a persons' self-reporting may not always reflect their choices in reality. That is, these approaches may not accurately expose latent preferences that drive consumer decision making.

But perhaps the most significant drawback to relying on conventional surveys and focus groups to gather effective market research data is simply that it is difficult to find participants. Many people are simply unwilling to participate in market research (e.g., email messages or dialogs on a website are often disregarded by consumers) and many people feel uncomfortable providing personally identifying or demographic information online. As a consequence, relying solely on the cohort of people who are willing to participate in a direct consumer survey often skews the results. Lastly, a business may be too aggressive in trying to attract participants for market research surveys, and doing so may itself damage a business' brand. For example, if every time a user visits a website they receive multiple prompts to participate in a consumer survey, some consumers may simply avoid that website or develop negative opinions about such a business.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates an example computing infrastructure used to conduct market research using social games, according to one embodiment.

FIG. 2 provides a logical view of a game platform for conducting market research using social games, according to one embodiment.

FIG. 3 illustrates an example workflow for conducting market research using social games, according to one embodiment.

FIG. 4 illustrates an example of a computing system used to create social network games configured to collect desired market research from game participants, according to one embodiment.

FIG. 5 illustrates an example computing system used to play social network games configured to provide game play events useful for deriving market research data as part of game play, according to one embodiment.

FIG. 6 illustrates a method for generating a social network game configured to collect desired market research from game participants, according to one embodiment.

FIG. 7 illustrates an example of an interface used to customize a social network game template, according to one embodiment.

FIG. 8 illustrates a method for gathering market research data from game participants, according to one embodiment.

FIGS. 9A-9C illustrate an example social game configured to gather both demographic and consumer preference data from game participants, according to one embodiment.

FIGS. 10A-10B illustrate an example social game configured to gather consumer preference, trending, and sentiment data from game participants, according to one embodiment.

FIGS. 11A-11B illustrate an example social game configured to gather market research data regarding consumer sentiment, according to one embodiment.

FIG. 12 illustrates an example of an interface used to gather market research data from game participants, according to one embodiment.

FIG. 13 illustrates another example social game based on prediction cards, according to one embodiment.

FIGS. 14A-14B illustrate yet another example social game based on prediction cards, according to one embodiment

FIGS. 15A-15B illustrate example interfaces for presenting market research data from the social game based on prediction cards, according to one embodiment.

FIGS. 16A-16D illustrate an example social game used to gather market research data using game play tailored for a mobile device, according to one embodiment.

FIGS. 17A-17C illustrate an example social game which includes two-player card-based game play, according to one embodiment.

FIG. 18A-18C illustrate an example online game which includes a single-player token or tile arrangement based game play, according to one embodiment.

### DESCRIPTION OVERVIEW

One embodiment of the invention includes a method of conducting market research using an online game played by a plurality of participants. This method may generally include providing, to each of the plurality of participants, a set of prediction cards. Each prediction card specifies a measure for determining a point value of the prediction card based on a corresponding future event identified by the prediction. Further, the online game is configured to allow each participant to retain or discard each of the prediction cards. This method may generally include providing, to the plurality of participants, a first interface for a first one of the participants to selectively trade prediction cards in the set of the first participant with a prediction card in the set of one the second participants. This method may also include monitoring, by operation of a processor, (i) a count of how many times a respective prediction card is discarded by one of the participants and (ii) trades made by respective first and second participants.

Another embodiment includes a method of conducting market research using an online game played by a first participant on a handheld device. This method may generally include selecting a cell in a grid of cells rendered on a display of the handheld device, and determining a current challenge to present to the first participant on the display. The current challenge requests the first participant capture an image of a specified object, via a camera on the handheld device, and the subject of at least one current challenge corresponds to a market research topic. This method may further include receiving either (i) an indication from the participant to pass on the current challenge or (ii) the requested image to use to fill in the selected cell. The steps of this method may be performed repeatedly until either (i) a specified time period has elapsed or (ii) the first participant has filled in a specified configuration of cells in the grid.

Still another embodiment includes a method of conducting market research using an online game played by a first participant and a second participant. This method may generally include presenting a prediction question to the first participant. The prediction question is associated with a game play card in the online game and corresponds to a first market research topic. This method may further include presenting the prediction question to the second participant, receiving, from the first and second participants, an estimate of an answer to the prediction question, and providing, to the first and second participants, a plurality of game play cards. Each card poses a statistical question having a known value, and wherein the question posed by one or more of the game play cards corresponds to a second market research topic. This method may further include presenting, by operation of a processor, a respective game play interface to the first and second participant. The first and second participants each play one of the game play cards during each of a set number of rounds via the respective interfaces.

Yet another embodiment includes a method of conducting market research using an online game played by a first participant. This method may generally include during a first time period, (i) receiving, from the first participant, a selection of a plurality of tiles and (ii) receiving, from the first participant, an arrangement of the selected tiles. Each tile presents a question related to an event that will occur during a second time period. The selection includes an estimated answer of the question posed by each selected tile and one or more of the questions correspond to a respective market research topic. The arrangement orders the selected one or more tiles in a connected chain having an ascending order, beginning from a tile having a lowest estimated value. This method may further include, following the second time period, (i) replacing, the estimated value in each tile with an actual value for each of the event presented in each selected tile, (ii) beginning from the tile having the lowest estimated value, toppling subsequent tiles in the connected chain until encountering a subsequent tile having an actual value that is not in ascending order, and (iii) awarding a score to the first participant based on a length of the toppled tiles in the connected chain.

Other embodiments include, without limitation, a computer-readable medium that includes instructions that enable a processing unit to implement one or more aspects of the disclosed methods as well as a system configured to implement one or more aspects of the disclosed methods.

### DESCRIPTION OF EXAMPLE EMBODIMENTS

Embodiments of the invention provide techniques for conducting market research using social network games. One embodiment provides a platform for creating and hosting online games which can identify latent consumer sentiment (and other market research data), while simultaneously providing an entertaining and engaging experience for the game participants. More generally, social network games may be tailored where elements of game play elicit responses from participants that reveal the desired market research data, e.g., consumer product awareness, consumer sentiment, brand preferences, loyalty, trends in awareness and sentiment, etc. Providing an engaging online experience provides an element of situational distraction, leading to more authentic responses from the participants as well as greater participation rates. Further, by providing games through social network websites (and applications used to access such online social networks), participants may be recruited by the users of such networks, helping to alleviate one of the most difficult aspects of conducting market research—finding willing participants.

In one embodiment, a game platform provides an evolving suite of games, which may be repeatable for different market research tasks. That is, a game played once to identify consumer sentiment or awareness relative to one product may be replayed using different data to identify consumer sentiment or awareness of another product. Further, by having the same participant play one or more games repeatedly, a user demographic profile, e.g., an expected predicted age, location, age-range, gender, and education level of the first participant, income, personality trait, or predicted behavior, etc., may be derived from the answers given by that participant. Additionally, a psychographic profile may be derived for a participant, i.e., profile of any attributes relating to personality, values, attitudes, interests, or lifestyles of a participant. Doing so allows game content to be targeted to groups of users having a desired demographic or psychographic attributes.

The game platform itself may be accessed from a variety of network-enabled devices, including computing devices with a web browser, e.g., a desktop laptop, or tablet or mobile telephone. Similarly, custom applications may be executed on these and other devices (e.g., game consoles, network capable music players etc.). Regardless of how a given user accesses a given game (or games), by creating an engaging experience, users are more likely to participate in games, resulting in statistically relevant amount of research data being collected at lower costs then possible with conventional survey or focus group approaches.

While the game platform described herein may support a broad variety of games, one example of a game configured to elicit consumer preferences (and general sentiment) is an online game which allows participants to select between at least two alternatives (usually two products) and then to guess what percentage of users will chose each alternative (revealing perceptions of consumer preferences). The user (or users) who correctly predicts the overall ratio could win the alternative they chose. When a given a user plays several iterations of this game, a profile of that participant can be developed, e.g., by inferring gender, age, location, etc. Another example game would be one where users make predictions by answering questions. Each answer could be associated with a game token. The game tokens can then be played in a variety of games that follow familiar rules, e.g., dominoes, gomoku, jenga, etc. When the predictions mature, tokens with correct predictions contribute positively to the score in each particular game. The points could be redeemed for product related to the game (or for other value).

Still another game could include one where participants are randomly matched with one another (or matched based on friendship status on a social network site or matched on demographic characteristics). Matched participants play a guessing game with one another where one is given a secret keyword (e.g., a product name or move title) and set of descriptors with concepts related to the keyword. The first player selects what descriptors or concepts to reveal to the second player, who in turn attempts to guess the keyword. The descriptors and concepts selected by the first user (as well as the guesses made by the second user) are used to interpret of consumer opinion relative to a target product. Further, after completing a round of this game, the first and second user could interact via a chat room. In such a case, any conversation between the participants about the target product, or the concepts and descriptors, could be mined as a secondary source of market research data.

Another variation includes presenting the first user with a question related to a product (or brand or celebrity, etc.). The second user is then presented with the first user's answer to the question along with multiple possible products. The goal for the second user is to select the correct product, based on the first user's answer (or selection of descriptors or concepts). Again, doing so reveals valuable information regarding consumer sentiment and awareness of the target product. Still another variation includes a game where two participants are presented with a product (or brand or celebrity, etc.) and a common set of descriptors or concepts. Each user then selects a set number of the keywords, and each matching keyword results in points for the two users. Again, the points could be redeemed towards the products presented in the game (or for other value), giving participants a stronger incentive to play.

Of course, one of ordinary skill in the art will recognize that many games may be configured to elicit relevant game play events that may be interpreted to derive market research data for a brand, product, service, individual, etc., including games for a single participant, games for multiple participants, games which include cooperative or competitive game play aspects (or both). And further, that the games playable through the game platform described herein (and corresponding approaches for game play events relevant for market research) are not limited to the specific examples of social network games presented below.

Note, the following description is presented to enable one of ordinary skill in the art to make and use the proposed techniques. Descriptions of specific embodiments and applications are provided only as examples and various modifications will be readily apparent to those skilled in the art. The general principles described herein may be applied to other embodiments and applications without departing from the scope of the disclosure. Thus, the present disclosure is not to be limited to the embodiments shown, but is to be accorded the widest scope consistent with the principles and features described herein. For purpose of clarity, features relating to technical material that is known in the technical fields related to the proposed ideas are not been described in detail.

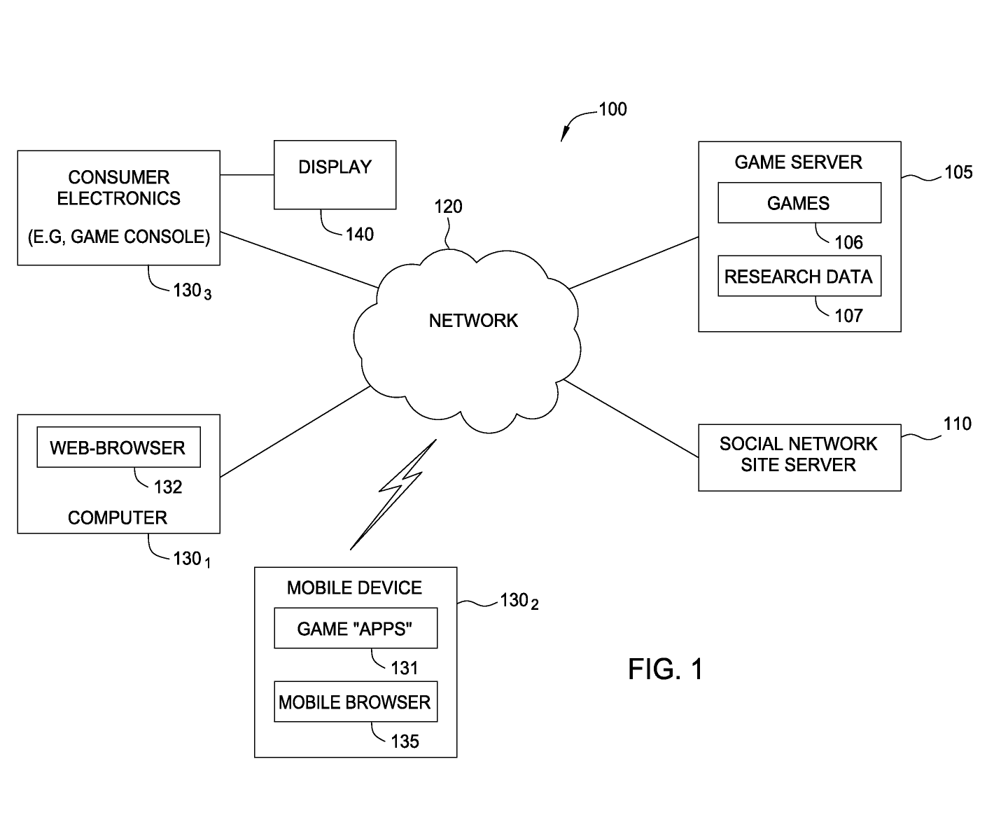

FIG. 1 illustrates an example computing infrastructure 100 used to conduct market research using social games, according to one embodiment of the invention. As shown, the computing infrastructure 100 includes a game server 105, a social network site server 110, and client systems 130₁, 130₂ and 130₃, each connected to a communications network 120.

The client systems 130₁₋₂ communicate with the game server 105 over the network 120 to access games 106 hosted by the game server 105. Participating in the available games 105 elicits game play events used to derive market research data 107 from game participants, which may be evaluated to determine, e.g., consumer product awareness, consumer sentiment, brand preferences, loyalty, and trends for the market research topic identified in the received set of data, purchasing behavior and purchasing intent, etc. Games 106 hosted by the game server 105 may also be accessed over a social network website (or application used to access such a site) hosted by the social network site server 110. For example, the game server could include a number of game templates, customized to conduct market research related to a specific product (or brand, service, concept, person, movie, television program, etc.). In such a case, the resulting games 106 could be published to the social network site (or other network accessible location), allowing members of that social network to access games 106, as well as recommend a given game to friends. As noted, doing so may be an effective approach for recruiting individuals to participate in market research, albeit doing so indirectly—by having users recommend (or invite) friends to play games 106 published from the game server 105. In each case, however, user game play elicits response relevant to the desired market research which may be communicated back to the game server 105 (or other computer system) for evaluation.

In this particular example, client system 130₁ represents a computer system running a web-browser 132. Accordingly, client system 130₁ is representative of desktop PCs, laptop computers, home-theater PCs (HTPCs), and other computing systems capable of running a web-browser. Similarly, client system 130₂ represents a mobile device such as a mobile telephone, tablet computer, portable MP3 player, etc. As shown, the mobile device 130₂ includes a mobile web-browser 135 as well as dedicated game “apps” 131.

In one embodiment, the games 106 are accessed using the web browser 132 or mobile browser 135, e.g., by accessing the social network website hosted by server 110. Alternatively, games may be distributed as stand-alone application programs (or “apps” 131) executed on the mobile device 130₂. In such a case, a game “app” 131 could include the basic template for a given social network game and access new content each time a user desires to participate in game play. For example, a game “app” 131 could be configured to present a user with a new choice of alternative products every day, where the user specifies their own preference, as well as guesses what percentage of users will chose each alternative (revealing perceptions of consumer preferences). As the same user plays each day, a demographic profile or psychographic profile of that user may be derived from the daily selections. Further, changing the selections each day helps retain user interest, as does offering participants a chance to win their selected alternative by accurately predicting the overall percentages.

Consumer electronics device 130₃ represents a set-top device connected to both network 120 and a display 140 (e.g., a flat-panel television). Accordingly, consumer electronics device 130₃ is representative of digital cable boxes, digital video recorder (DVR) systems, video game consoles, and other media devices capable of rendering web content or executing a game application. Further, display 140 may itself be an integrated device capable of connecting to the network 120 and rendering web content. For example, some flat-panel television displays include integrated applications that can connect to a social network site, stream media from video on demand services, etc. In each of these cases, a user interface presented by the consumer electronics device 130₃ may provide a mechanism for a user to participate in social network games configured to derive market research from elements of game play.

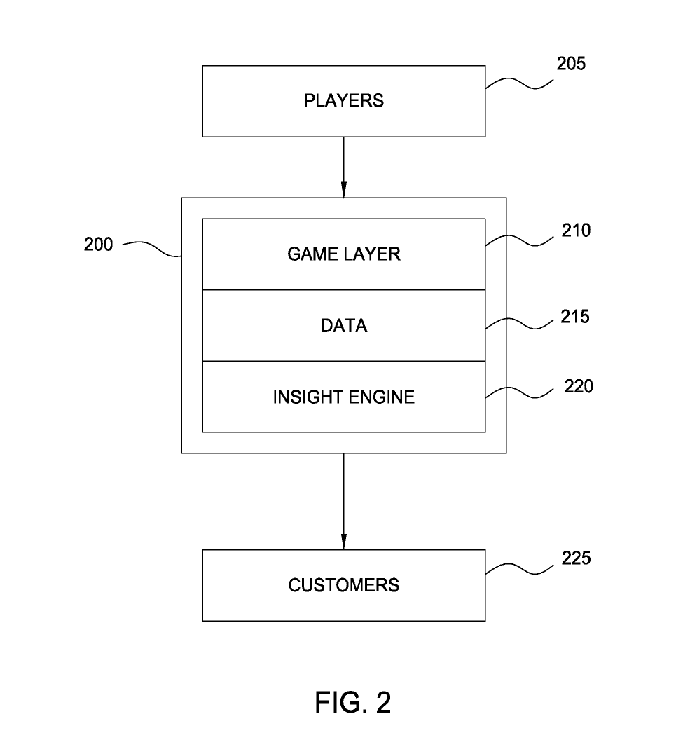

FIG. 2 provides a logical view of a game platform 200 for conducting market research using social games, according to one embodiment of the invention. As shown, the game platform 200 includes a game layer 210, market research data 215 and an insight engine 220. As described, players 205 can access game layer 210 of the platform 200 via a web browser, mobile device, social network sites, etc., to access an evolving suite of repeatable games. That is, the game layer 210 exposes each game currently available for a player 205 to play. Data 215 corresponds to data collected, over time, at a participant-level, including a given users' product/brand choices/awareness/sentiment, etc., revealed during game play. Data 215 also includes demographic predictions regarding a given participant, an identification of most insightful and/or relevant players, etc.,

The insight engine 220 provides a software application configured to identify sentiment, preference, awareness, and predicted outcomes. That is, the insight engine provides the analytics for the game platform 200 to interpret relevant game events that occur during game play to derive the desired market research data. The analytical findings may be distilled into actionable market research returned to customers 225, e.g., business conducting market research to a brand, product, etc., via the games published to the game layer 210.

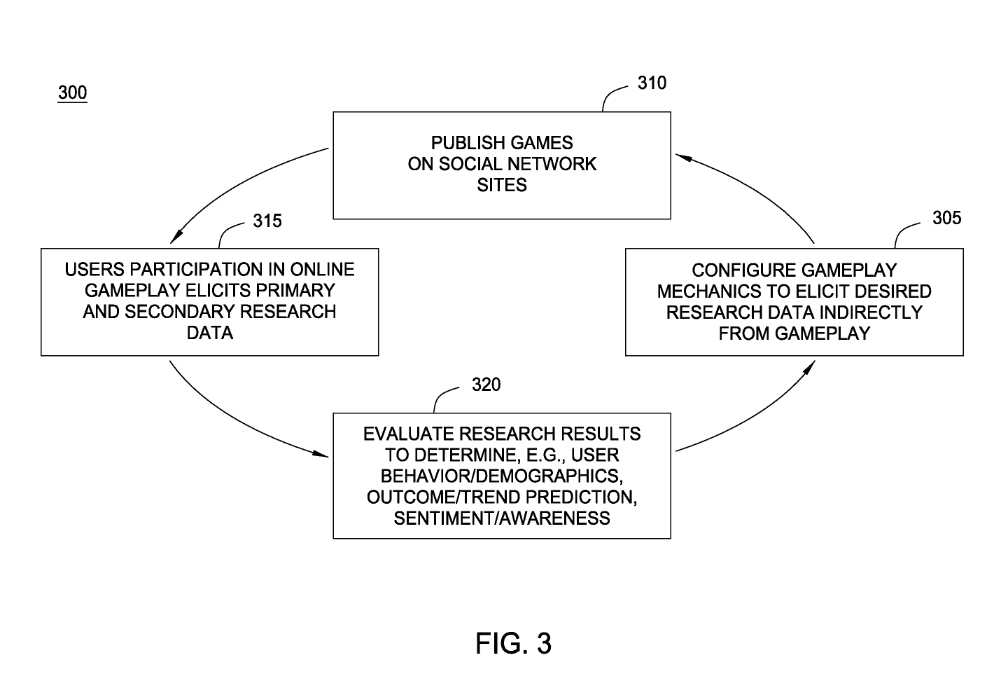

The general workflow for conducting market research via the game platform 200 is shown in FIG. 3. As shown, the workflow 300 begins at 305, where the game play mechanics for a given game are configured. In one embodiment, the games themselves may be defined using a set of templates associated with a given game type, and a sponsor desiring to conduct market research supplies the appropriate information to customize the template into a playable game. For example, returning to the preferences game where a user expresses their preference between two alternatives, the sponsor would need to specify the particular alternatives to present to users.

Once the game data associated with a given game type is provided, at 310 the resulting game is published to a network accessible location, allowing users to participate in game play, as well as invite friends to participate. At 315, user participation in online game play may elicit both primary and secondary research data. Primary or “relevant” data generally includes any information or events reveled or occurring as part of game play (directly or indirectly) related to the market research topic (e.g., consumer brand awareness or sentiment). And secondary data generally includes other information revealed by a participant related to the market research topic. For example, for games that include multiple participants, chat messages exchanged among game participants may include information useful to the market research topic.

At 320, the market research data revealed/elicited during game play, is evaluated to determine, e.g., user preferences, demographics, outcome and trend prediction, sentiment, awareness, etc. Further, given the rapid response and potential large participation rates for a given game, the results learned from one game mechanic, can be used to design additional market research topics. For example, assume a motion picture studio is preparing to release an animated feature with a primary target audience of families and children. In such a case, the studio could identify from the results of one preferences test that pre-release marketing of the film had resulted in a consumer perception that the animated feature was primary a “girls” movie. In the appropriate case (i.e., depending on the actual content of the movie), the motion picture studio could engage in new advertising campaigns to change this perception (e.g., by advertising aspects of the movie that would appeal more to boys). Further still, given the rapid development and deployment of games provided by the game platform, the impact of such a change in marketing could be determined in near-real time. More generally, the game platform 200 and workflow 300 may be used to evaluate trends in consumer sentiment over time, and allows a business to correlate different marketing campaigns with different audiences (demographic cohorts) over time.

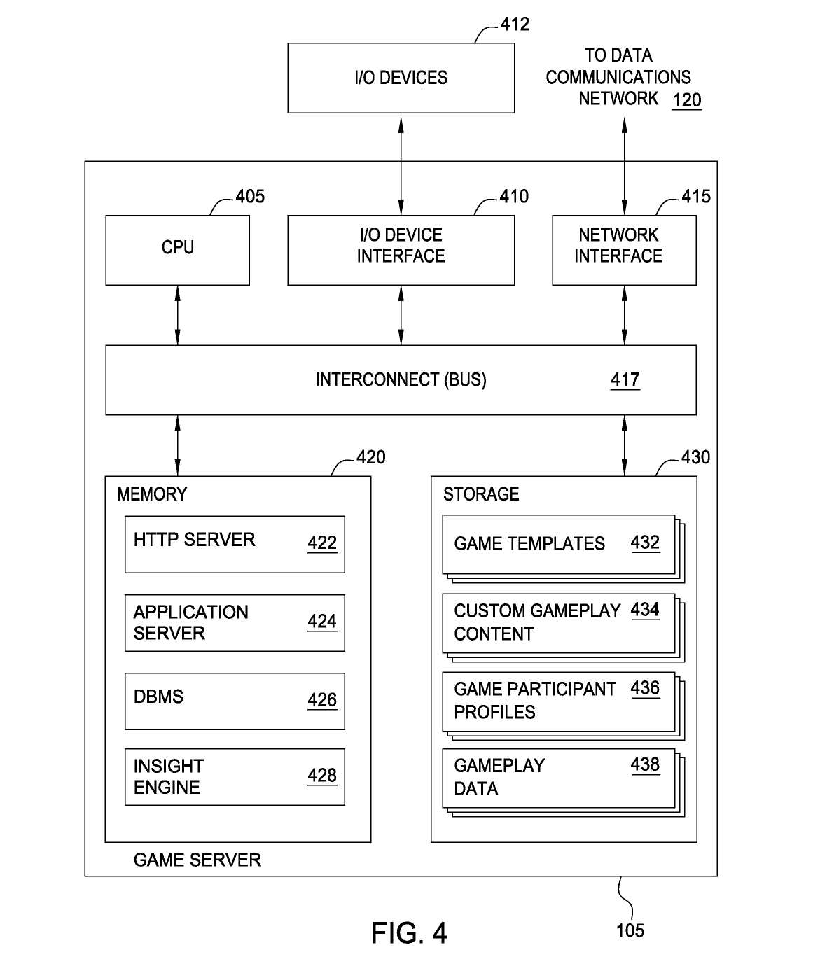

FIG. 4 illustrates an example of a game server 105 used to create social network games configured to collect game play events useful for market research from game participants, according to one embodiment of the invention. As shown, the game server 105 includes, without limitation, a central processing unit (CPU) 405, a network interface 415, a bus 417, a memory 420, and storage 430. The game server 105 also includes an I/O device interface 410, connecting the game server 105 to I/OP devices 412 (e.g., keyboard, display and mouse devices). As described, the game server 105 provides a computing system configured to transmit game content to a social network site (or to game participants directly).

CPU 405 retrieves and executes programming instructions stored in the memory 420. Similarly, CPU 405 stores and retrieves application data residing in the memory 420. The bus 417 is used to transmit programming instructions and application data between the CPU 405, I/O devices interface 410, storage 430, network interface 415 and memory 420. CPU 405 is included to be representative of a single CPU, multiple CPUs, a single CPU having multiple processing cores, and the like. And the memory 420 is generally included to be representative of a random access memory. The storage 430 may be a disk drive storage device. Although shown as a single unit, the storage 430 may be a combination of fixed and/or removable storage devices, such as magnetic disc drives, solid state drives (SSD), removable memory cards, optical storage, network attached storage (NAS), or a storage area-network (SAN).

Illustratively, the memory 420 includes a web-server 422, application server 424, and a database management system (DBMS) 426, collectively configured to respond to requests for web pages or for game content. Additionally, the memory 420 also includes an insight engine 428. As noted, the insight engine 428 provides a software application configured to identify sentiment, preference, awareness, predicted outcomes, etc., from market research data elicited, revealed, observed, or derived from game play. Of course, one of ordinary skill in the art will recognize that the insight engine 420 may be executed be on a separate computer system from the game server 105, and that the game server 105 itself is representative of multiple computer systems used to create games to publish to a network accessible location, e.g., social network site (or to users), to load balance requests for game content, to store market research data generated as a result of game play, and to evaluate such market research data using the insight engine 428.

Illustratively, the storage 430 includes a collection of game templates 432, custom game play content 434, game participant profiles 436 and game play data 438. In one embodiment, each game template 438 corresponds to a game type or game mechanism that can be customized to identify consumer sentiment, awareness, trends, purchasing intent, etc., relative to a given brand, product, etc. Custom game content 434 generally corresponds to information used to tailor a game to a desired market research topic or subject prior to being published on a social network website (or made available to users via another network accessible location). Once a given game template is used to generate a game, and the resulting game is published, participants may begin playing that game. The game play events used to derive market research data is stored as game play data 438.

Similarly, the game participant profiles 436 provide demographic profiles or psychographic profiles (or both), corresponding to game participants generated, over time, as participants engage in game play. For example, in one embodiment, users access a social network site using a user name and password. In such a case, each time a given user accesses the social network site and participates in game play, responses elicited during game play can be correlated with statistical data to derive a predicted demographic profile of that user. Thereafter, where a market research sponsor desires to conduct market research data for a given demographic cohort, the game participant profiles 436 may be used to select participants that satisfy the desired characteristics. Note, doing so does not require any personally identifying information about game participants to be supplied directly. Instead the participant profiles 436 may be built-up over time as a given user plays multiple games. Of course, in one embodiment, the participant profile 436 may include information supplied by the user (e.g., as part of a user profile associated with a given user name and password).

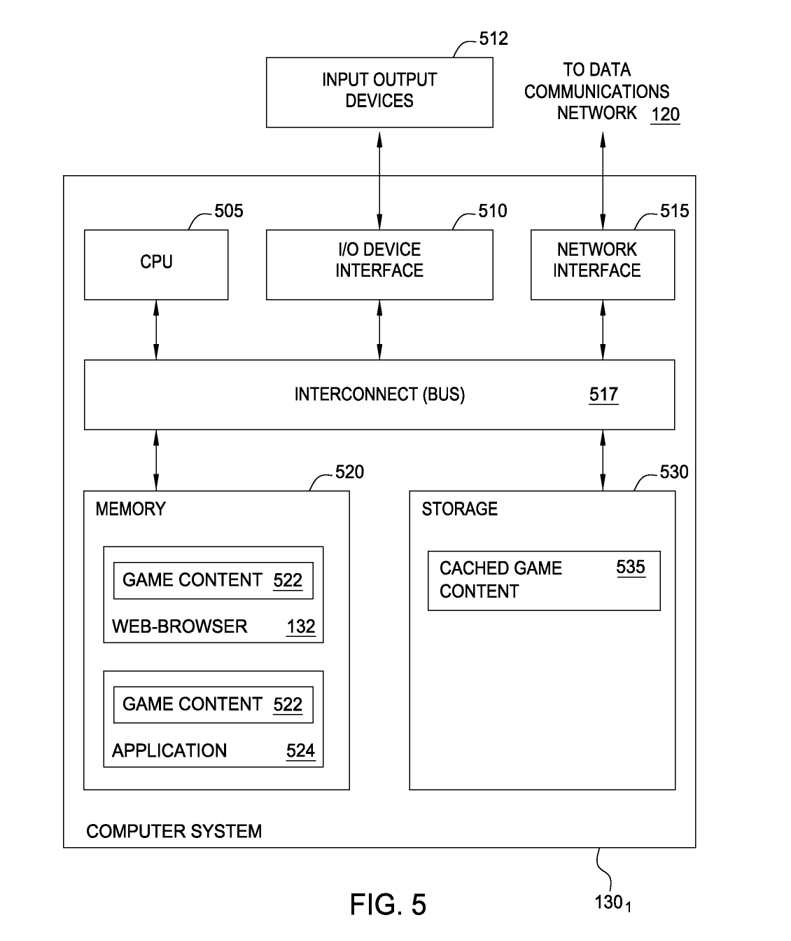

FIG. 5 illustrates an example computing system used to play social network games configured to provide game play events useful for deriving market research data as part of game play, according to one embodiment of the invention. As shown, the client computing system 130₁ includes, without limitation, a central processing unit (CPU) 505, a network interface 515, a bus 517, a memory 520, and storage 530. The computing system 130₁ also includes an I/O device interface 510 connecting I/O devices 512 to the computing system 130₁ (e.g., a keyboard, mouse, or remote control, along with a monitor (e.g., an LCD panel).

Like CPU 405, CPU 505 is included to be representative of a single CPU, multiple CPUs, a single CPU having multiple processing cores, etc., and the memory 520 is included to be representative of a random access memory. The bus 517 connects CPU 505, I/O devices interface 510, storage 530, network interface 515, and memory 520. The network interface 515 is configured to transmit data via the communications network 120, e.g., to obtain games from the game server system 105. Storage 530, such as a hard disk drive or solid-state (SSD) storage drive, may store game data files along with other content.

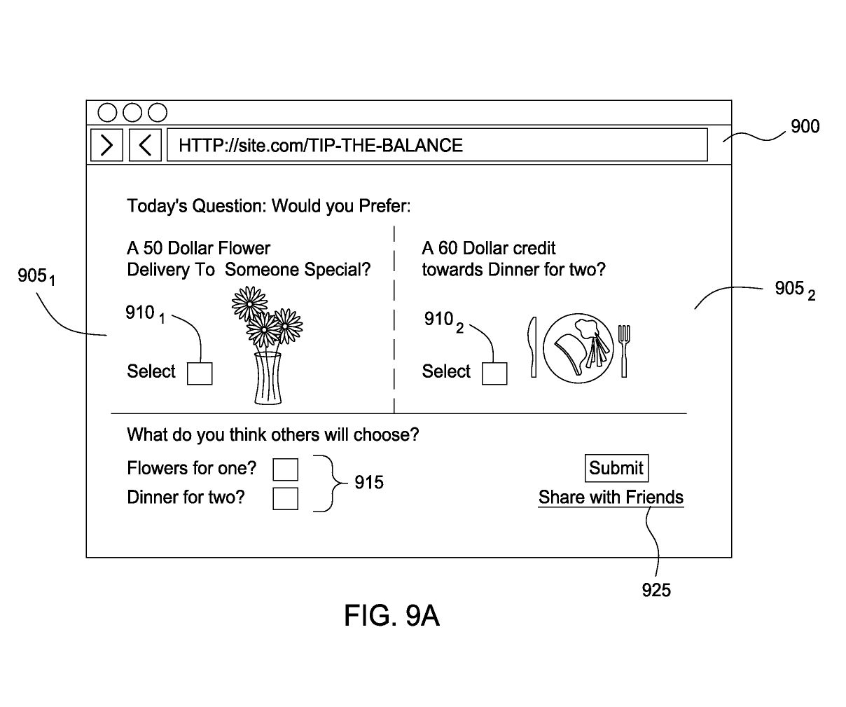

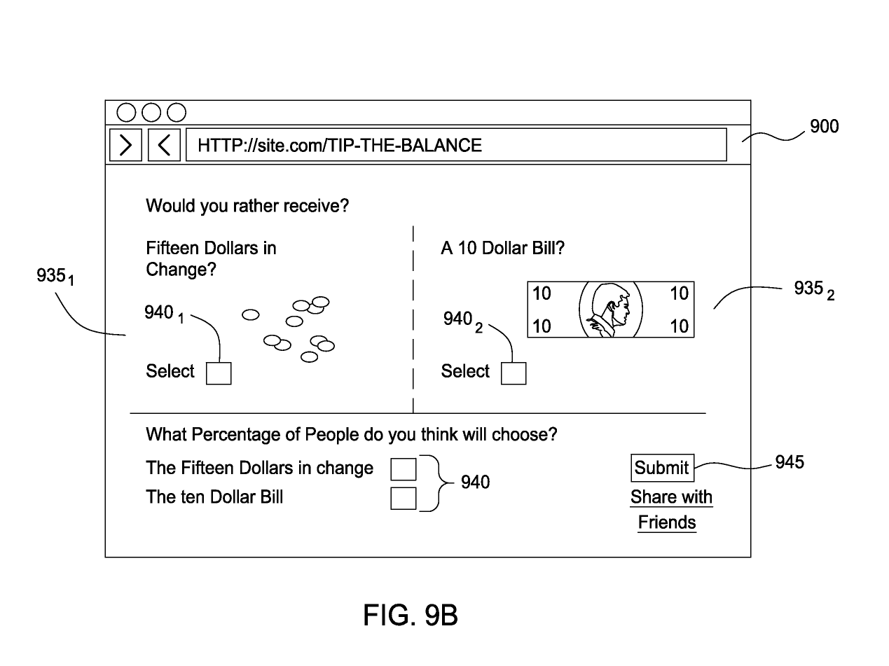

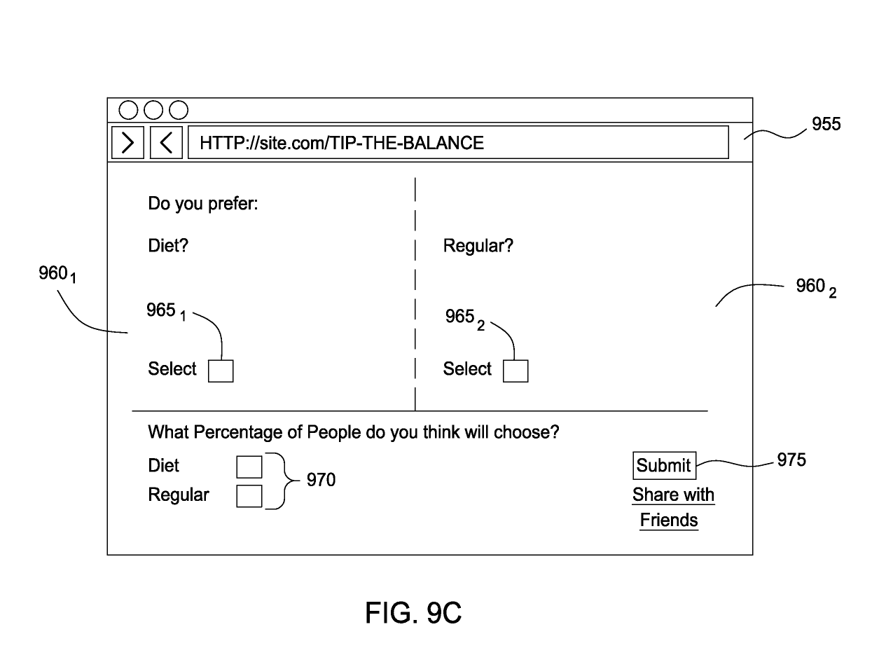

Illustratively, the memory 525 includes a web browser 132, which itself includes game content 522. The memory 520 also stores an application 522 which executes game content 522, outside of the context of a web browser. And storage 535 stores cached game content 535 and user configuration setting as needed to facilitate game play. As described above, the web browser 132 may access a social network site to obtain game content, allowing a user to participate in game play, as well as capture game play events based on the game play choices made by a participant. FIGS. 9 through 12, discussed below present, a variety of example games 522 rendered by a web browser 522.

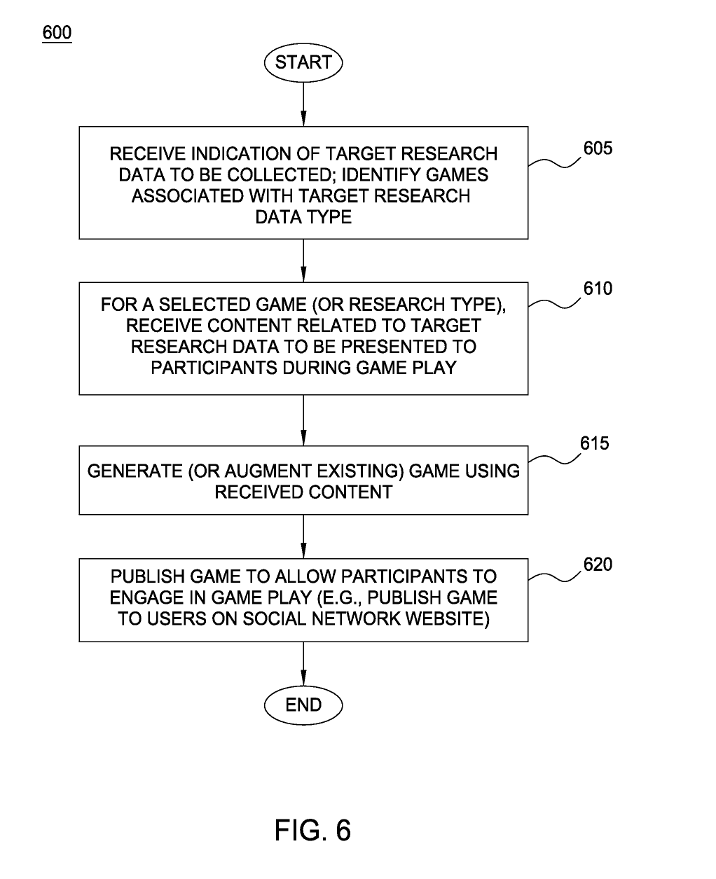

FIG. 6 illustrates a method 600 for generating a social network game configured to collect desired game play events from game participants useful for market research, according to one embodiment of the invention. As shown, the method 600 begins at step 605, where a game server receives an indication of a target research data to be collected, and in response, identifies games, game types, or game mechanisms matching the requested game type (or matching the requested market research data type).

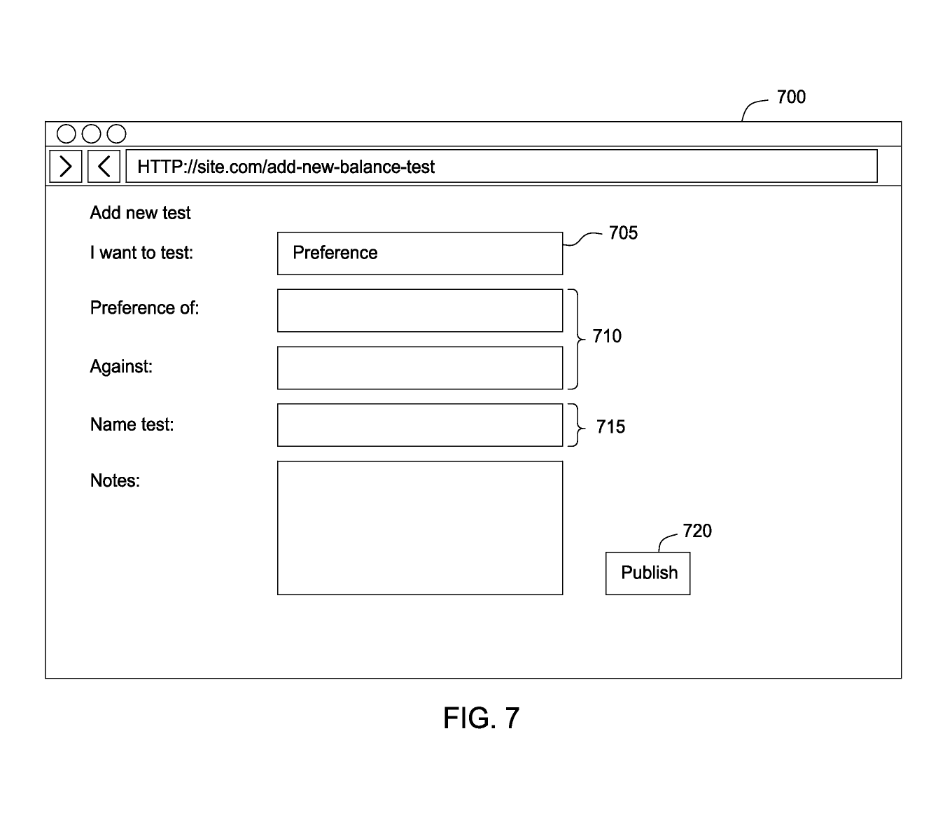

For example, FIG. 7 illustrates an example of an interface 700 used to customize a social network game template, according to one embodiment of the invention. As shown, the interface 700 includes a section tool used to specify a type of market research to obtain via a social network game. In this particular example, a research type of “consumer preference” has been selected using selection list 705.

At step 610, the game server prompts a research sponsor to specify the content needed to create a social network game for the selected game template (or research type). At step 615, the game server generates a game using the information provided by a research sponsor. And at step 620, the sponsor publishes the game at a network accessible location to allow participants to engage in game play.

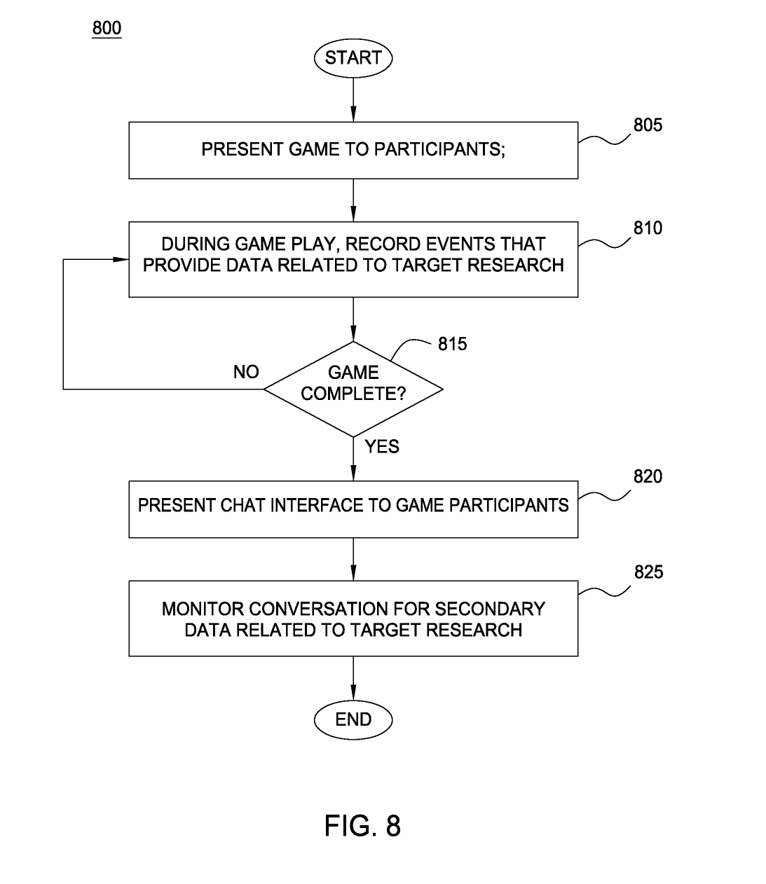

For example, the interface 700 of FIG. 7 shows two text fields 710 used to specify alternatives for the game type of “consumer preference.” In this specific, case, assume a research sponsor specifies two choices for an NB test presented to game participants. And to play this game, a user selects which alternative they prefer along with a guess regarding what percentage of users will chose each alternative (revealing perceptions of consumer preferences). The user (or users) who correctly predict the percentage ratio could win the alternative that they chose (or other value). Examples of this game are given in FIGS. 8A-8C discussed below.

In addition to specifying the product alternatives for the “consumer preferences” game type, a research sponsor may also specify a name for a given instance of this game using text box 715 as well as store notes regarding a given game instance—allowing the sponsor to access this instance later as well as review all games created by a given sponsor. Similarly, the name may be used to identify the game data generated by individual participants during game play.

After supplying the information necessary to create a game of a given game (or research) type, the sponsor can publish the game using button 720. Continuing with the preferences example, the specified alternatives may be grouped with instances of this game type, allowing this instance of the “consumer preferences” game to be presented to participants. Once the preferences of a specified number of participants have been obtained (or after a prescribed time period), the results may be determined and a “winner” announced.

FIG. 8 illustrates a method 800 for gathering market research data from game participants, according to one embodiment of the invention. The method 800 begins at step 805, where a game is presented to a participant. As described above, the game may be presented on a web browser as well as on specialized applications executing on mobile phones, tablet computers, and the like. At step 810, a participant engages in the appropriate game play for a given game. During game play, events that provide data related to target market research data are collected and sent to the game server. Game play continues until a given game is over (steps 810 and 815), according to the rules/mechanics of that particular game.

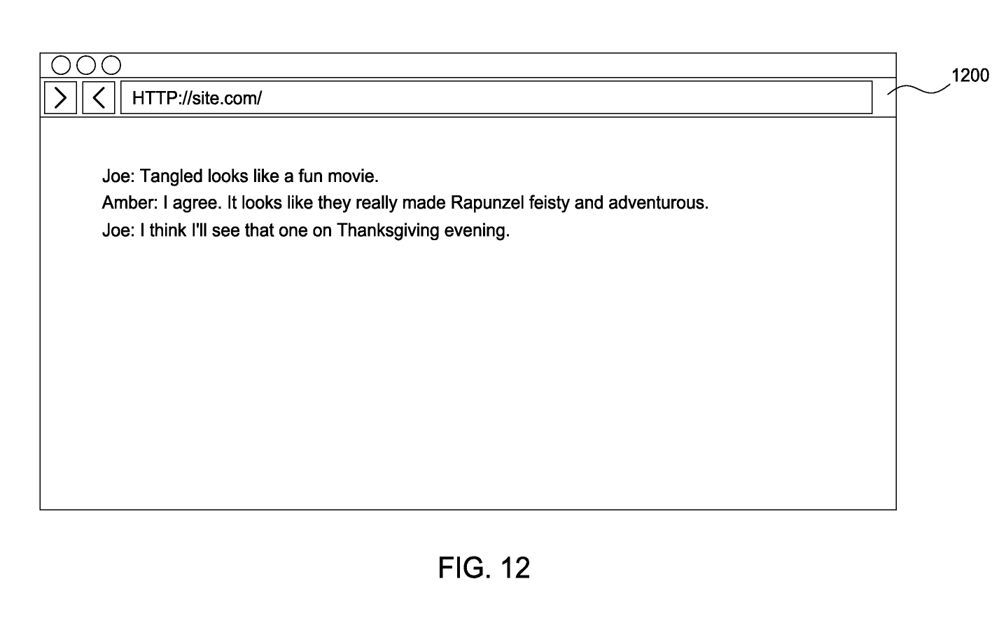

In one embodiment, game participants can chat with one another following a given game. For example, some games may allow two (or more) participants to engage in cooperative and/or competitive game mechanics. In such a case, at step 820, the participants are presented with a chat interface, allowing the participants to discuss the events of a particular game. At step 825, the chat interface may monitor the ensuing conversation of game participants to capture additional market research data related to game play events (and to the objects/subjects of the target market research). An example of such an interface is discussed below in reference to FIG. 12.

FIGS. 9-18 illustrate a collection of game interfaces for a variety of different game mechanisms used to capture market research data from game participants. Of course, one of ordinary still in the art will recognize that the user interfaces shown in these figures provide example embodiments of an interface configured to capture market research data and that the example game interfaces may be modified in a variety of ways to add, remove, of combine user-interface elements as presented, or otherwise construct a game interface configured to provide game play mechanisms to participants.

FIGS. 9A-9C illustrate an example social game configured to gather both demographic and consumer preference data from game participants, according to one embodiment of the invention. The social game shown in FIGS. 9A-9C provides examples of the “consumer preferences” game discussed above. As shown in FIG. 9A, a web page 900 presents a game interface that allows a user to select between two alternatives. In this example, the first alternative 905₁ is a fifty-dollar gift certificate for flowers, and the second alternative 905₂ is for a sixty-dollar gift certificate good towards dinner for two. A participant can make their selection by checking one of the checkboxes 910₁₋₂ and submit it using button 920. Additionally, text boxes 915 allow the playing participant to specify what percentage of other participants will select one alternative over the other. In addition to playing the game, one participant can recruit other players using link 925.

FIG. 9B illustrates a second example of the “consumer preferences” game interface. In this example, a web page 930 shows a first alternative 935₁ is fifteen dollars in change and the second alternative 930₂ is for a ten-dollar bill. A participant can make their selection by checking one of the checkboxes 940₁₋₂ and submit it using button 945. Additionally, text boxes 940 allow the playing participant to specify what percentage of other participants will select one alternative over the other. This example illustrates that in addition to product preferences, this game can be used to measure other aspects of consumer behavior. Specifically, the choice of accepting a larger amount of change versus a single bill may be a good proxy for identifying participants who are more time sensitive than price sensitive.

FIG. 9C illustrates another example of the “consumer preferences” game interface. In this example, a web page 955 shows a first alternative 960₁ of “diet” and the second alternative 960₂ of “regular.” A participant can make their selection by checking one of the checkboxes 965₁₋₂ and submit it using button 965. Additionally, text boxes 970 allow the playing participant to specify what percentage of other participants will select one alternative over the other. This example illustrates that in addition to the direct information related to product preferences, this game can be used to build up a demographic profile for a given participant. Specifically, the choice presented in this example of the “consumer preferences” game may correlate to some degree to the gender of the playing participant. While not conclusive on its own, the latent signal in this choice may be combined with others to characterize the likelihood that a given participant has a given gender, age-range, location, education level or a variety of other demographic markers. Building a demographic profile of participants allows a provider of market research using the game platform described herein to offer more selective market research services to research sponsors. For example, research sponsors may be more interested in learning the awareness or consumer sentiment for their product relative to cohorts having a certain gender, age-range or other demographic marker.

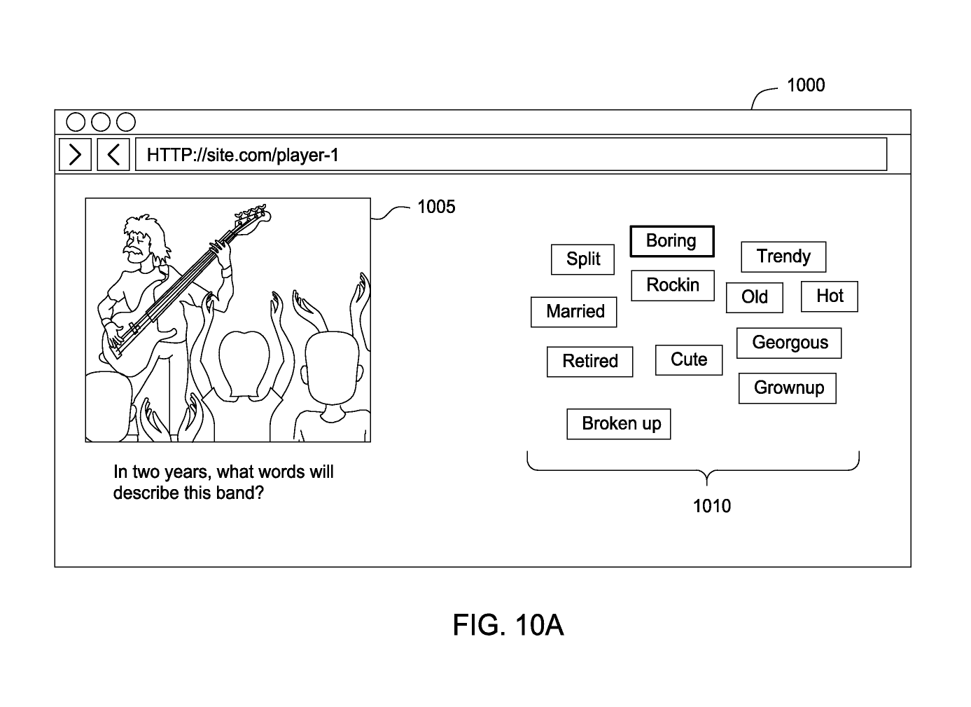

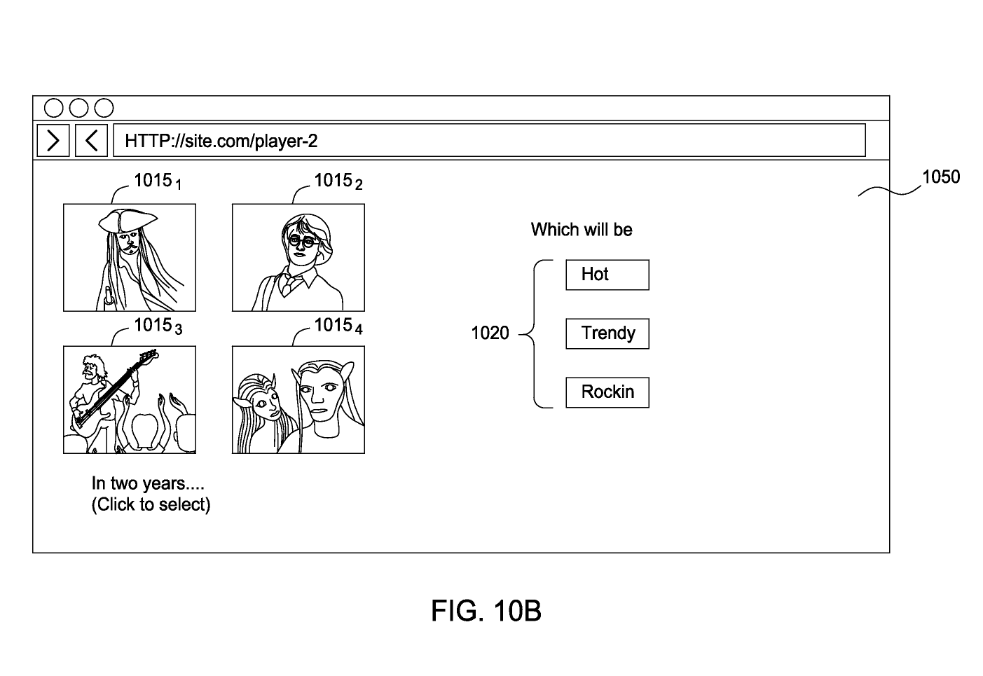

FIGS. 10A-10B illustrate an example social game configured to gather consumer preference, trending, and sentiment data from game participants, according to one embodiment of the invention. Unlike the example of FIGS. 9A-9C, the social game shown in FIG. 10A is played by two participants. The interface shown in FIG. 10A is presented to the first player. In this game, the first user is presented an image of a product, brand, celebrity, etc. In this particular example, a panel 1005 shows the first player an image of a popular music band and asked what words will best describe the group two years in the future. Along with the image, a set of word choices 1010 are available to the first user. The word choices 1010 provide a set of descriptors and concepts used to learn the consumer perceptions of the first user. Game play for this game includes the first user selecting the most appropriate set of keywords, based on their perception of the band shown in panel 1005. The selected concepts and/or descriptors are presented to the second user.

For example, FIG. 10B shows an interface 1050 presented to the second user. As shown, the choices of descriptors and/or concepts made by the first user are presented to the second user (at 1020). However, in addition to the band presented to the first user, the interface 1050 also includes panels 1015₁₋₄, only one of which corresponds to the band shown to the first user. Game play proceeds where the second user selects which one of the panels 1015₁₋₄ the second user believes the selected words best correspond to. If the second user selects the same image presented to the first user, then the participants are considered to have “won” the game, and could be rewarded, e.g., with a free mp3 download from the band (assuming the word choices indicated the first and second user liked this band, if not the users could be offered other value). Either way, the research sponsor is provided with a significant market research data regarding the consumer perceptions, preferences and/or awareness of the first and second user relative to the market research topic. Another variation of this game includes presenting both the first and second user with the same image panel (e.g., the image of the band shown in the panel 1005 of FIG. 10A) and the same collection of word choices. In such a case, game play could include each participant selecting a specified number of top choices. The more matching choices between the first and second participants, the higher the “score” for that round of the game.

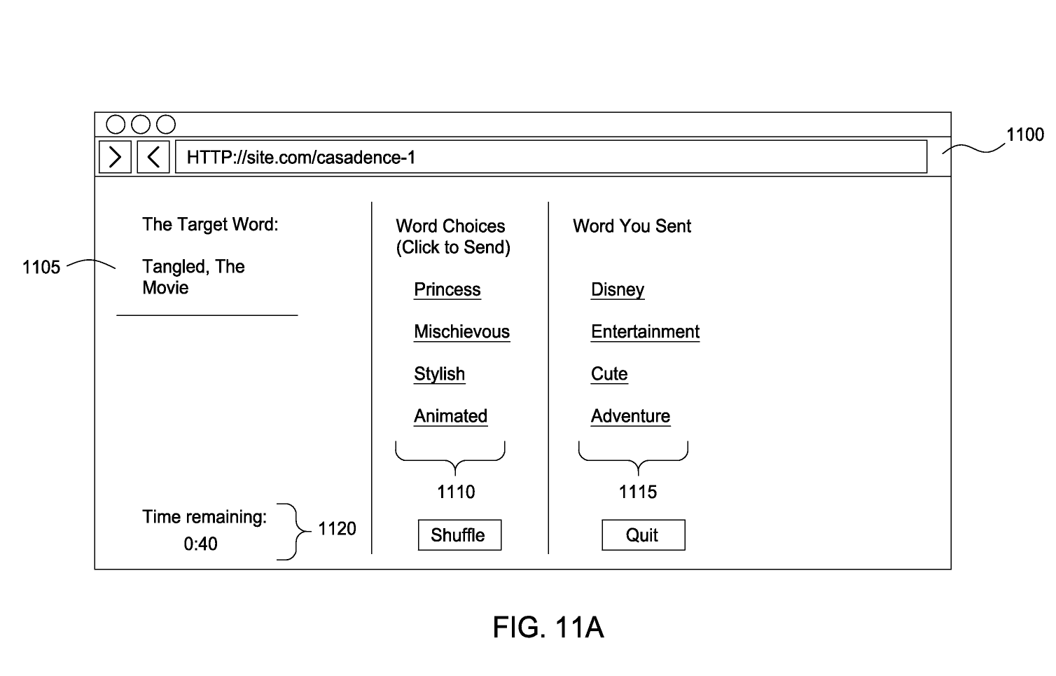

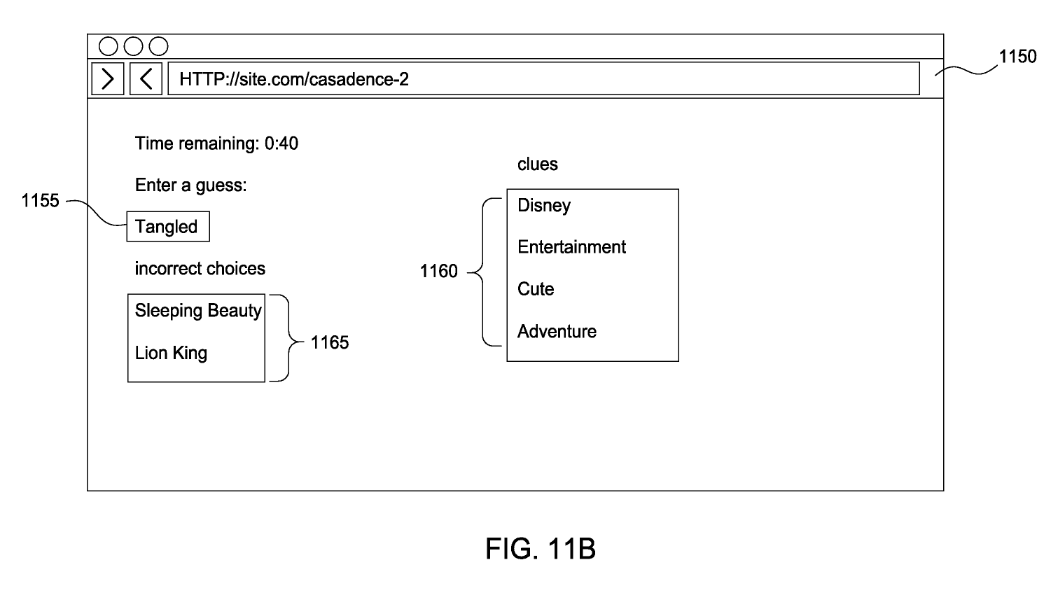

FIGS. 11A-11B illustrate another example social game configured to gather market research data regarding consumer sentiment, according to one embodiment of the invention. In this example, game participants are randomly matched with one another (or matched based on friendship status on a social network site or matched on demographic characteristics). Matched participants play a guessing game with one another where one is given a secret keyword (e.g., a product name or move title) and set of descriptors with concepts related to the keyword. The first player selects what descriptors or concepts to reveal to the second player, who in turn attempts to guess the keyword. The descriptors and concepts selected by the first user (as well as the guesses made by the second user) are used to derive measures of consumer opinion relative to a target product.

The interface 1100 shown in FIG. 11A is presented to the first player. In this particular example, the first user is presented with the name of an animated feature and a set of keywords 1110. Game play includes the first user selecting which keywords to send to the second player. To send a keyword, the first player clicks on one of the keywords. In response, the interface 1100 removes the selected keyword from set 1100 and moves it to list 1115. In addition, the selected word appears on an interface presented to the second player, who attempts to guess the secret word supplied to the first player.

For example, FIG. 11B shows an interface 1150 presented to the second user. As shown, the choices of descriptors and/or concepts made by the first user are presented to the second user (at 1160). Additionally, a text box 1155 allows the second user to guess the secret keyword, based on the concepts and/or descriptors selected by the first user. Incorrect guesses are shown at 1165.

Game play proceeds where the second user enters guesses until time runs out or correctly guesses the keyword presented to the first user. If the second player guesses correctly, the participants are considered to have “won” the game, and could be rewarded, e.g., with a discount movie passes, assuming the word choices indicated the first and were interested in seeing this particular movie. If not the users could be offered other value. At the same time, the word choices selected by the first user (as well as the guess made by the second user relative to a growing set of concepts and or descriptors) provide valuable market research data to a research sponsor (e.g., in this case, the motion picture studio producing and marketing the animated film).

In cases where the second user fails to guess the keyword, the second player could be prompted to indicate what keywords would have “given it away.” The first user could also be prompted to indicate which keywords they would have most wanted to have available. Doing so provides an additional source of market research data. In one embodiment, the responses could be used to update the word choices made to available to the first player

Further, after completing a round of this game, the first and second user could interact via a chat room. In such a case, any conversation between the participants about the target product, or the concepts and descriptors, could be mined as a secondary source of market research data. For example, FIG. 12 illustrates an interface 1200 used to gather market research data from game participants, according to one embodiment of the invention. As shown, the interface 1200 allows the first and second player to discuss the last round of game play. In this particular example, elements of the conversation related to the animated motion picture provide an additional source of market research data to the film studio.

Another online game used to conduct market research allows participants to build a portfolio of cards and trade them with other participants. In this game, each card may have a point value associated with the predicted event, e.g., one point for each five-million dollars of ticket sales during a motion picture's opening weekend. The face point value for each card is selected to generally have an expected equal value (e.g., 5 points) when a given card is first introduced. However, the perceived value of that card may change over time, as people's perceptions regarding the predicted event change. When the event related to a given prediction occurs, a final point value for that card may be obtained—and players holding that card in their portfolio are awarded the appropriate amount of points. Game play includes discarding and trading prediction cards, with a goal of discarding or trading away a prediction that a participant finds to be less valuable over a prediction that the participant believes to be more valuable. Participants can trade a straight exchange of cards as well as trade for cards and points together.

The predictions may be related to a variety of topics, e.g., media and entertainment, products and branding, politics, sports, etc. Further, a user may build a portfolio for a group of topics or limit their participation to selected topics of interest. In each case, participants may be allowed to build a portfolio by discarding cards and trading with others. As predictions mature, points are awarded. A game cycle may be limited to a set of predictions maturing or a specific period of time (e.g., 30 days) after which the participant holding the best portfolio is considered to be the “winner” and may be awarded a fixed prize. Similarly, participants may be allowed to exchange the points they are awarded for their portfolio for value.

Market research data can be derived from a variety of aspects of game play. For example, the ratio of (1) players that retain a given card to (2) players who discard that card provides a “crowd-sourced” evaluation of whether the card is worth more or less points than other cards, and/or whether the card is worth more or less than the initial value. As stated, the initial value of each card is set to a roughly equal value, i.e., each card is defined to have an expected value comparable to any other new card. For example, assume a studio expects an opening weekend box office (OWBO) of $25 million, and points for the card are measured as one-point per $5 million. In such a case, this card has an initial expected value of five points. Participants that retain that card (over others) may believe that the OWBO is going to exceed the five point value. Further, the patterns of participants dealt or trading a given card can reveal trends in consumer perception as well as measures of relative value between cards.

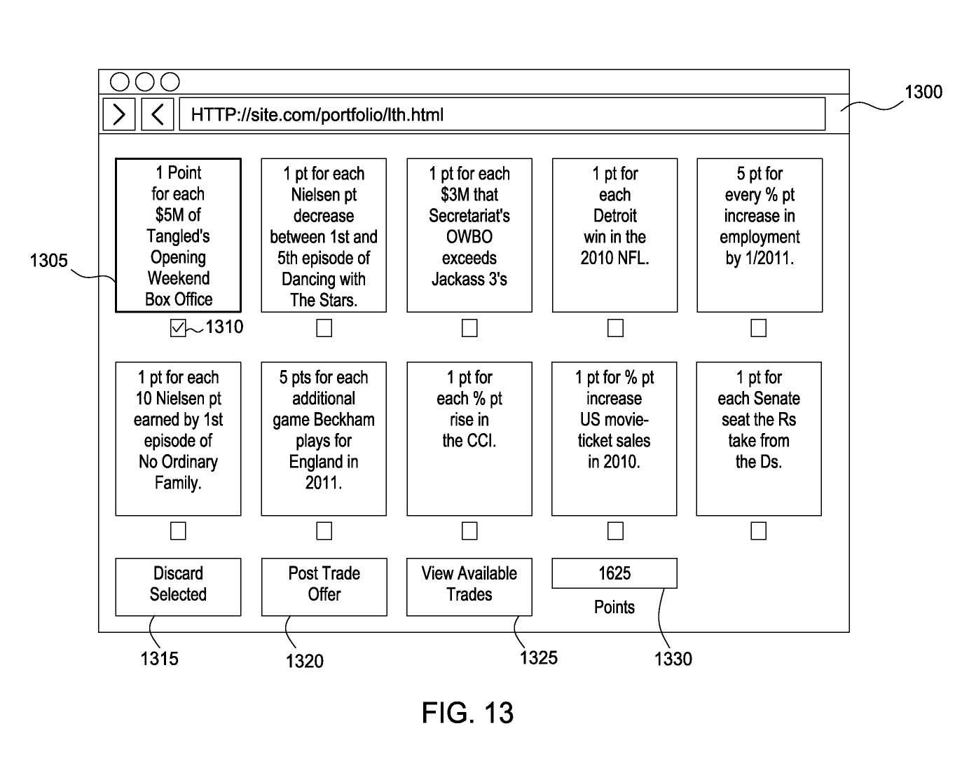

FIG. 13 illustrates an example social game based on prediction cards, according to one embodiment. As shown, an interface 1300 presents a portfolio of cards dealt to a participant. For this example, assume a participants' portfolio includes ten predictions cards. Further, when dealt, a participant may be allowed to discard a certain number of cards, replaced randomly with other prediction cards. In one embodiment, a user may be limited in the number of prediction cards that may be discarded (or discarded over a given time period). This may encourage participants to build a portfolio by trading cards with one another, rather than simply discarding cards. Note, a user may have (or trade for) multiple cards of the same prediction.

As shown, interface 1300 shows a portfolio of ten cards. Cards are related to movies and entertainment, television, sports, and politics. Of course, the content of a card (or deck of cards) can be tailored depending on the market research desired by a given research sponsor. For example, a producer/distributor of a motion picture may sponsor a card 1305 to measure a crowd-sourced opinion of how well a movie will do during its opening weekend. This card may be placed in a deck of cards sponsored by other entities. If the participant dealt card 1305 believes the movie will have a stronger opening weekend, they may choose to keep this card. Otherwise, the card may be discarded by selecting checkbox 1310 and pressing button 1315. The participant may manage their portfolio by posting trade offers using button 1320 and viewing trades offered by other participants 1325 via the game platform 200 discussed above. Additionally, interface 1300 shows the current points 1330 that this participant has earned through trades or matured predictions. In one embodiment, points may be traded for value, used to rank participants relative to one another, as well bartered with prediction cards to facilitate a given trade.

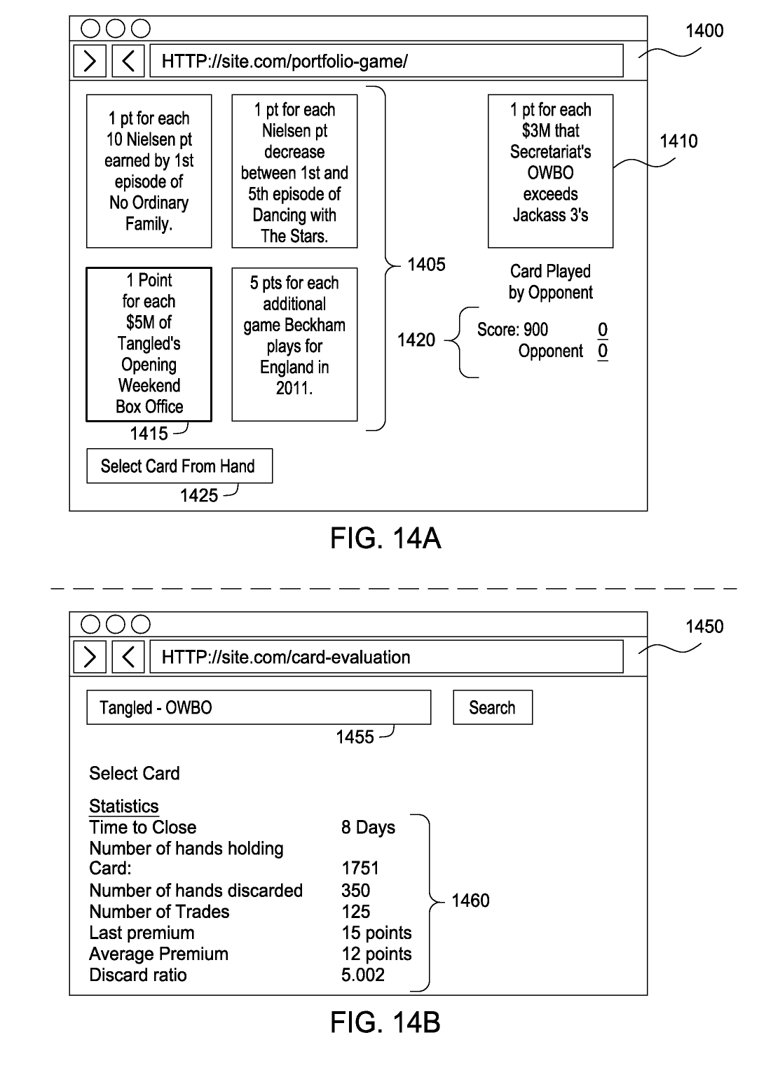

FIG. 14A shows another variation where participants play a hand of prediction cards against one another, according to one embodiment. In this example, each participant is dealt a hand of five prediction cards. Cards are played against one another in five tricks. As shown in an interface 1400, one participant has a hand 1405 of five cards, each specifying a different prediction. Interface 1400 also shows a card 1410 that has been played for this trick by an opponent. To play the game, the participant selects a card from their hand (e.g., card 1415) and presses button 1425 to “play” this card in this trick. In one embodiment, a “discard ratio” is used to determine which participant's card should win the trick. The “discard ratio” may be determined as a number of times a card has been discarded by a participant that has dealt that card to a number of participants that hold a given card. Calculated this way, the card with the lower discard ratio wins a point for that participant, shown in FIG. 14A as score 1420. The rounds continue until all five cards have been played, with users alternating who plays the first card for each trick.

FIG. 14B shows an example interface 1450 showing market research data derived from the prediction card games shown in FIGS. 13 and 14A, according to one embodiment. As shown, a user may select (or search for) a given prediction card by name using text box 1455. Of course other approaches may be used (e.g., a sponsor may be presented with an interface with links to each prediction card defined by that sponsor). Once selected, the insight engine 220 (discussed above) may determine a variety of statistics 1460 revealing a “crowd sourced” opinion as to the relative (or absolute) value of that card. Illustratively, the statistics show the number of participants that hold the card as well as the number of hands from which the selected card has been discarded. These values are used to determine a discard ratio for this card. In addition, the statistics 1460 also show the number of trades involving the selected card as well as the premiums paid (or received) for trades involving the selected card.

More generally, the insight engine may provide a direct comparison between card X and card Y, such as the relative discard ratios of cards X and Y or the expected premium required to trade card X for card Y. Similarly, the insight engine may provide comparisons relative to the norm for all cards, such as the discard ratio for a given card or the premium required to trade a given card.

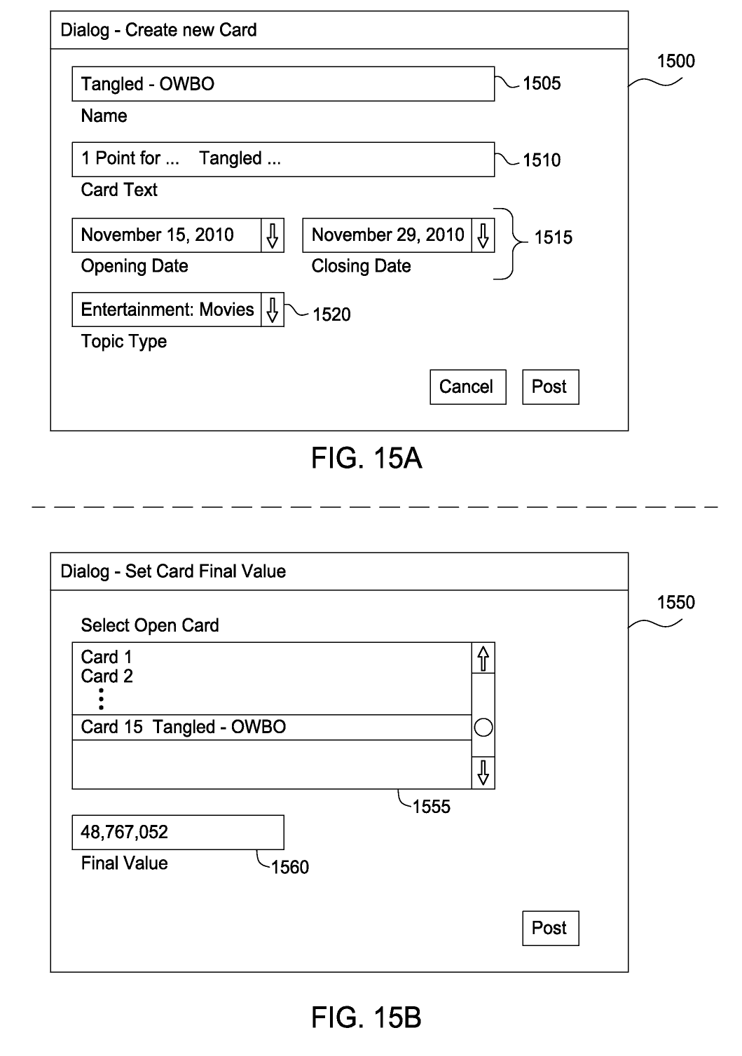

FIG. 15A shows an example interface 1500 for a research sponsor to create a new prediction card, according to one embodiment. As shown, the interface 1500 includes a name 1505 and the text 1510 for a new card. The interface 1500 also allows a research sponsor to set an opening date and closing date 1515. The closing date generally corresponds to the date when the event related to the production of a card will occur. In addition, interface 1500 also allows a research sponsor to specify a topic type 1520 for a new card. Of course, one of ordinary skill in the art will recognize that the interface 1500 is merely an example and a variety of graphical interface configurations may be used to allow a research sponsor to create a prediction card. Once the information for a card is specified, a research sponsor may post a card to the game server 200.

FIG. 15B shows an example interface 1550 for a research sponsor to review market research data related to a prediction card, according to one embodiment. As shown, the interface 1550 allows a sponsor to select one of their cards from a list 1555—in this example, the OWBO card for a major motion picture release. Once selected, the interface 1150 allows the sponsor to provide a final value for the event corresponding to the prediction. In this case, a final OWBO for a movie release. Illustratively, a value of $48,767,052 has been entered, making the final point value for this card to be nine points (at 1 point for every five million dollars of box office receipts). Once the final value is confirmed, users holding that card receive the appropriate number of points based on the actual results of the predicted event. Further the card may be removed from each portfolio that held the card, and replaced with another prediction card.

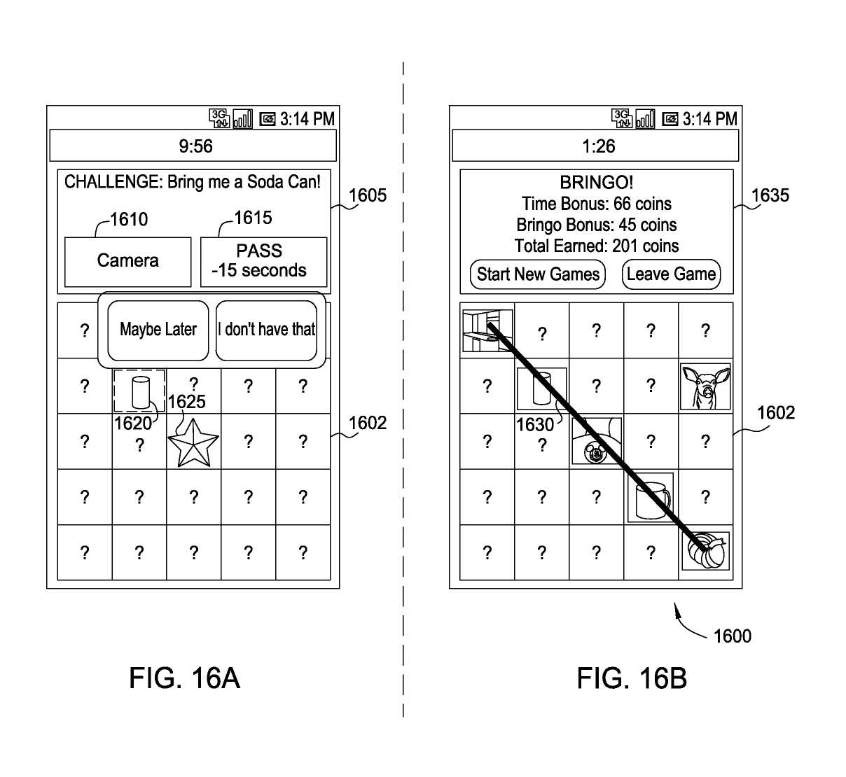

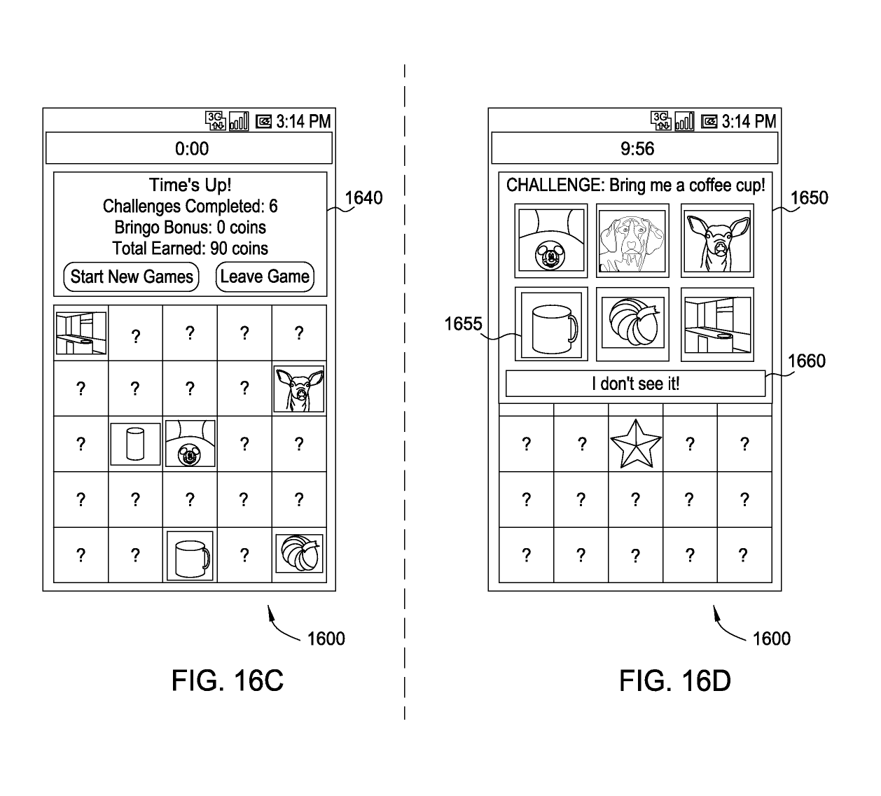

Another game type includes games tailored for mobile devices. For example, FIGS. 16A-16D illustrate a social game used to gather market research data using game play tailored for a mobile device, according to one embodiment. In this example, users play a game named, e.g., “Bringo” by filling in squares on a 5×5 grid of cells with pictures taken using a handheld device (e.g., a mobile phone or tablet computing device).

The objective of this game is to get five in a row of cells in a grid. A user can make five in a row diagonally, horizontally, or vertically. The user may play against a clock to perform a series of challenges which will involve taking pictures of items around them. Each challenge corresponds to a randomly selected cell on the grid and fulfilling that challenge will fill that box with an image captured using the camera on the mobile device. That is, to win a square on the Bringo grid, a user captures an image of a specified item in a participants' home. Thus game play includes elements of bingo (get 5 in a row) and a scavenger hunt (find item X). As shown in FIG. 16A a handheld device 1600 shows an interface for playing Bringo. After starting an instance of Bringo, a game applet on mobile device 1600 selects a cell in a grid 1602 and a challenge to present to the user. For example, as shown in FIG. 16A, the Bringo app has selected cell 1620 and presented a challenge screen 1605. The challenge screen 1605 asks a user to take a picture of a soda can. The user can activate a camera using button 1610 or pass using button 1615. Note, a collection of challenges may be cached on the device 1600 or retrieved from the game sever 200 individually. In this example, passing incurs a time penalty of fifteen seconds for a game with a total time limit of ten minutes. Further, if a user passes, the app requests to user to specify whether this challenge should be presented later or if the user does not have the item requested by the challenge.

Upon completing a challenge, the selected square on the Bringo grid will fill in with a thumbnail of the picture. In one embodiment, a user does not know which square the challenge corresponds to until the thumbnail fills that square. Additionally, a user may be rewarded with points for completing an individual challenge, as well as points for completing a five-in-a-row line.

Game play continues in this manner until a user completes a five-in-a-row line or until time runs out. For example, FIG. 16B shows an interface on device 1600 after a user has completed a diagonal 1630 five-in-a-row line. As shown, the images captured by the user for each completed challenge are shown in grid 1602. Additionally, a panel 1635 indicates that the user has completed a Bringo as well as the number of points earned by this user in this round. The number of points may depend on the number of challenges completed by a user as well as the amount of time remaining when the user completed a five-in-a-row line. The panel 1635 also allows the user to start another round or exit the Bringo app. In contrast, FIG. 16C shows an interface on device 1600 after time has expired without a user completing a five-in-a-row line. As shown, a panel 1640 presents a user with an indication that time is up as well as the number of completed challenges and earned points. The panel 1640 also includes buttons which allow the user to start another round or exit the Bringo app.

In this embodiment, game play may also include a challenge round in which the user selects from a series of pictures to fulfill the challenge. Fulfilling the challenge results in the middle square being filled in on the grid. In one embodiment, the center square challenge is used to validate images captured by other game participants playing the Bringo game. For example, assume a first participant completes a challenge to capture a picture of a can of soda. In such a case, the center square challenge for another participant may include presenting the image captured by the first participant along with other images and ask that the second participant identify the image with a can of soda.

FIG. 16D illustrates an example challenge interface 1650 on device 1600. As shown, the challenge interface 1650 includes an array of six images, along with a challenge used by the participant to identify the correct image. If the challenge interface does not include the requested image (i.e., an image of a coffee cup in this example), then the user can press the “I don't see it” button 1660. That user may then complete the challenge by capturing an image of a coffee cup (or passing). Note, the image in the challenge interface 1650 image which should satisfy the challenge will be marked as a possible instance of cheating. The user who originally took that image may be penalized by losing any coins gained from their Bringo round containing the cheating image. To provide an incentive to play, users can win value with the points earned during game play.

In one embodiment, most of game challenges are made to provide participants with entertaining game play (e.g., “capture me a picture of your pet”). However, some percentage of challenges (e.g., 25%) could be tied to a particular market research topic, subject, or question. For example, the example challenge that asks a participant to capture an image of a can of soda may be used to learn what brand of soda that participant might prefer (or at least have in their house). More generally, the Bringo app may be used to learn two broad categories of market research: a general request about a product type, e.g., “capture an image of a can of soda.” Alternatively, a specific request may ask a participant about a particular brand of a product, e.g., “capture an image of a can of Coke®”). A variety of similar questions may be tailored to learn about the brand preferences of a participant or what consumer items a person has within their household. At the same time, by presenting these market research questions in the context of an entertaining game on a mobile device obscures the fact that the game is being played to gather this type of market research information.

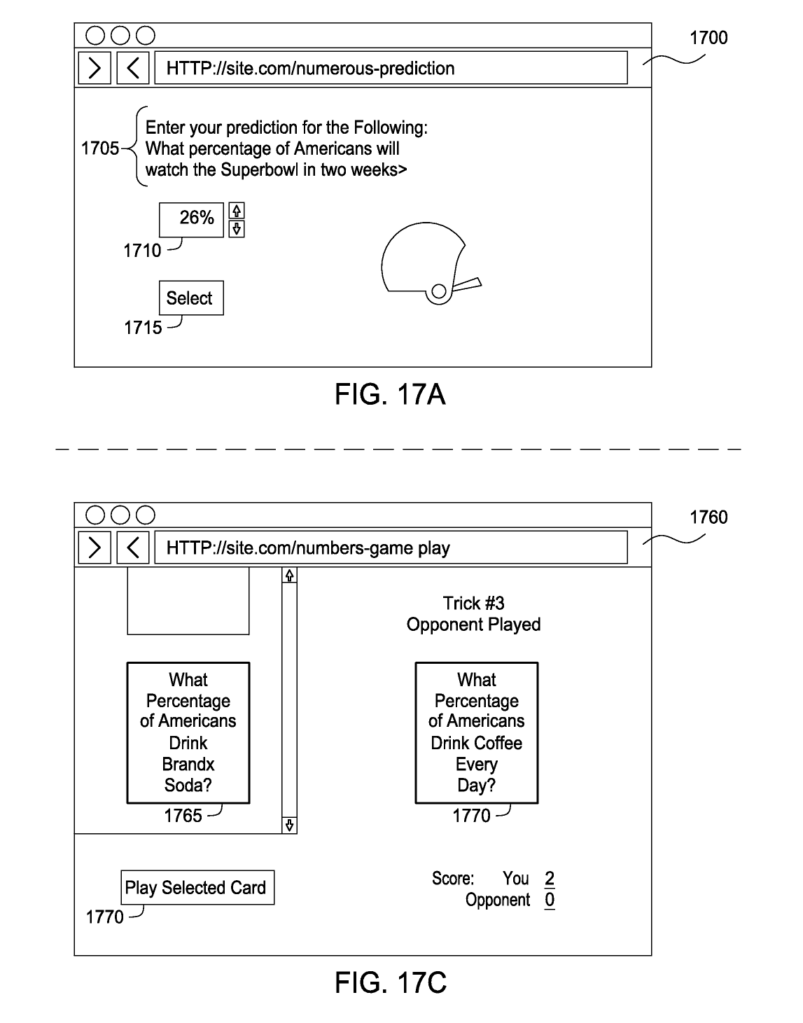

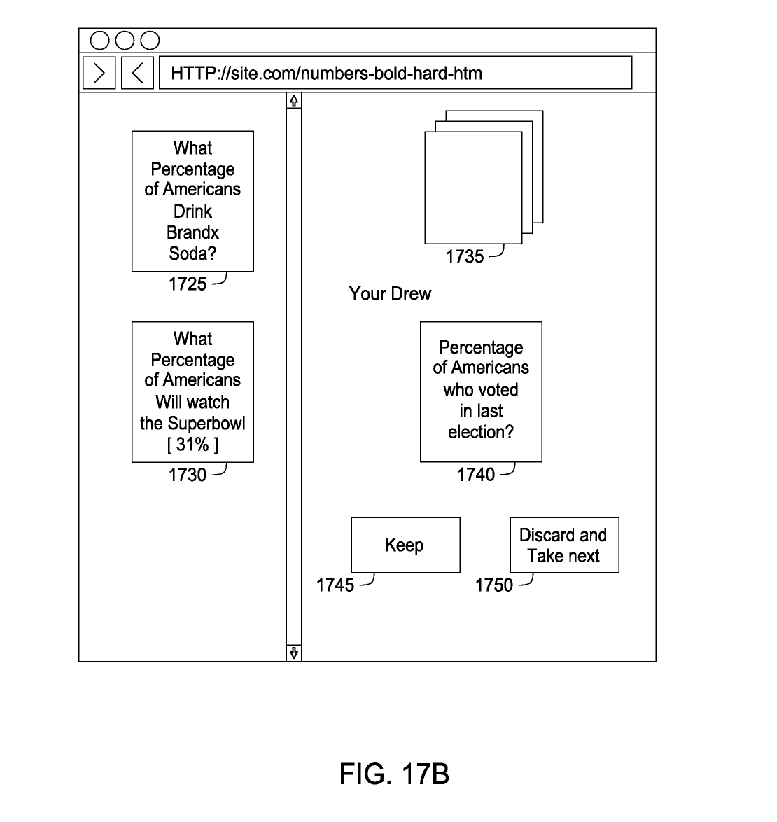

Still another game type includes card based games. Such games may be used to gather market research data from game participants as well as contribute to profiles related to game participants. For example, FIGS. 17A-17C illustrate a social network game, according to one embodiment. Market research data is captured by asking players to estimate a numeric value of a prediction question. Further, players have to estimate as known values for a variety of statistical information in the context of a competitive card game. In the example of FIG. 17A-17C, a social card based game includes three phases, a prediction phase (FIG. 17A), a card drawing phase (FIG. 17B), and a turn based game play phase ((FIG. 17C).

During the prediction phase, each player is presented a question and asked to guess an answer. To incentivize participants to answer truthfully, points may be awarded to the more accurate player once the subject/topic of a prediction matures. FIG. 17A illustrates an example interface 1700 presenting the prediction phase to a participant. As shown, a question 1705 asks a participant to predict how the size of the television audience for the NFL Super bowl football game. Both participants set a value for the question using interface element 1710 and button 1715. Note, in one embodiment, questions are asked in a manner that the answer can be expressed as a numerical value (or converted to a value) between 0-99. As described below relative to the game play phase, the numerical value is used to determine which player wins a hand, as cards are played against one another. For purposes of game play, the value of the prediction card could be set to the average selected by each participant.

After answering the prediction questions, each player builds a hand by drawing cards from a deck of cards. Each card describes a fact, instance, or event in terms of a value between 0-99, e.g., by stating the fact, instance, or event as a percentage. For example, FIG. 17B shows an interface 1720 used to build a hand of cards. As shown, a participant has one card 1725 in their hand along with the prediction card 1730. Note, the participants are not presented with the known value for the statistic presented by the card. Instead, the user relies on their own beliefs or perceptions about the statistic presented in the card to determine whether it is a “high” or “low” value. To build a hand, the participant is presented a card 1740 from the deck 1735, and then has an option of either retaining that card (by pressing button 1745) or accepting the next card in the deck, without knowing the contents of the next card (by pressing button 1750). This continues until a player has a complete hand (e.g., seven cards).

Once each player has a complete hand, the game play phase commences. During game play, each player selects a card to play during a turn. The player who goes first may be selected at random for the first round. Thereafter, the player who wins a given round goes first for the next hand. Should players tie, the round is considered a draw. FIG. 17C illustrates an interface 1760 where a participant has been presented with the opposing player's selection. Specifically, the opposing player has selected a card 1770 captioned “What percentages of American's drink coffee every day?” in the third trick of game play. The participant viewing interface 1670 selects a card believed to have a greater or lesser value (depending on the that player's strategy preferences and available cards). As shown in interface 1765, a user has selected a card captioned “What percentage of American's drink Brand-X soda?” To play this card, the user presses button 1770. Once played, the winner for this trick is determined based on the higher-valued card. Additionally, the actual statistical value for each card is presented to both participants. After all cards are played, the participant who won the most rounds is the winner. As with other games described herein, the winner may be rewarded points redeemable for value.

Market research may be gathered for this game both as part of the prediction phase as well as during game play. For example, each person's answer of the prediction question can be used to determine consumer sentiment, popularity, awareness, etc., for the subject/topic of the prediction question. Different research sponsors could create different prediction cards presented to users and learn a “crowd sourced” opinion or value regarding the prediction, i.e., a “crowd sourced” opinion as to the most likely answer to the question posed by the prediction card. Further, the player's selection of cards to keep or discard, as well as cards played during game play may be evaluated to determine a variety of market research data. Further still, the game may allow sponsors to learn what participants are more or less accurate in predicting certain types of events, values, facts, etc.

Still another game type includes token based games, where predictions are associated with tiles or dominos arranged by a participant on a game board. For example, game platform 200 may allow participants to play a game over a monthly time cycle, where predictions for the following month are made in the current month. For example, a user makes a set of predictions in March for events that will occur in April. In one embodiment, the prediction questions may be provided by a market research sponsor regarding a topic/subject of interest to that sponsor.

To provide an entertaining experience for game participants, each question may be presented on a domino tile and participants select which tiles to provide an estimate of the correct answer. A participant then creates chains from their tiles in ascending order of the estimated predictions. That is, users form chains with their tiles. At any given point, a tile can split into two (or more) chains. The primary requirement for forming chains is that the participant's answer needs to form a chain in ascending order, i.e., each tile must have a larger value than the next one in the chain. A participant can return to and update both the predicted answers and the changes up to the end of a game cycle.

At the end of prediction cycle (e.g., on the last day of the current month), the participant's chains are frozen. The predictions then mature over the course of the subsequent month. That is, at the end of the prediction cycle, the answers and chains created by a participant become fixed. As the actual values for the predictions become available, they replace the predicted values on each tile. When all the predicted events in a participant's chain have matured a “topple” takes place. The first domino tile falls, and if the correct answer to the second domino tile is greater than the correct answer to the first, the second tile falls. The tiles continue to “topple” so long as the correct values continue to increase along the chain.

The goal is to have the longest chain of correct answers. Points are awarded based on the longest chain of predictions, where the actual values for the predicted events have the same ascending order. That is, so long as the actual value for the next prediction in a chain continues to be greater than the actual value for the previous prediction, the chain continues to grow, like dominos toppling. Once the actual value of the next prediction is less than the current one, the chain ends. While a variety of scoring schemes may be employed, in one embodiment, the participant is awarded n² points for a chain of length n. Additionally, the participant may be awarded points for every domino that falls and points for the end of every chain (i.e., each time the toppling reaches the end of a branching chain). Points may also be awarded for correct predictions within a specified margin of error.

In one embodiment, a chain may be restarted if the predicted value for a subsequent tile is within a certain margin of error (e.g., +/−5%). Further, a participant may have a limited number of chances to restart a chain at a desired position.

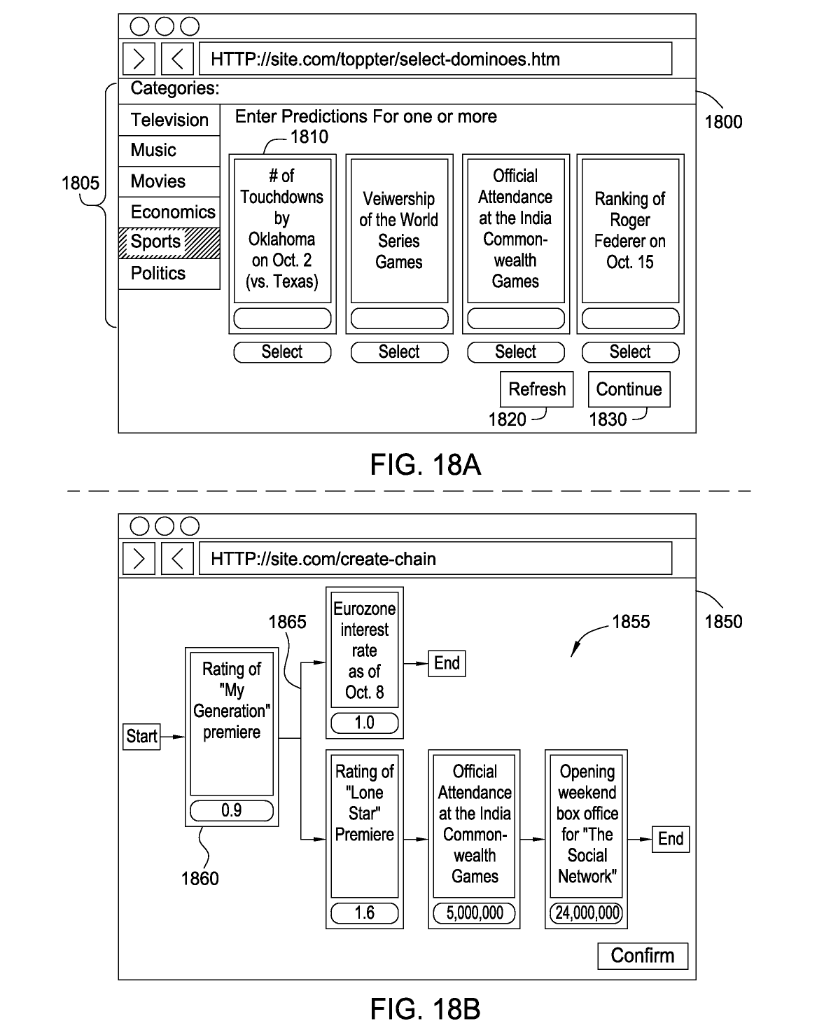

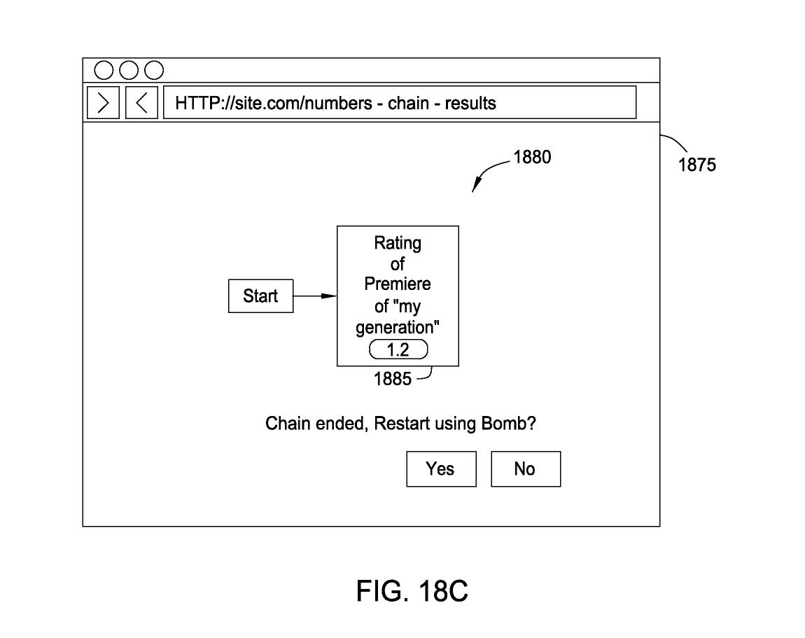

FIGS. 18A-18C illustrate an online game which includes a single-player token or tile arrangement based game play, according to one embodiment. First, FIG. 18A shows the tile prediction phase. As shown, an interface 1800 presents a set of categories 1805 to a participant. Illustratively, a “sports” category is selected and the participant may choose one or more of the tiles in this category to enter a prediction (e.g., tile 1810). The user may view an additional set of tiles in the current category using the refresh button 1820 or select another one of the categories 1805. Once a user completes entering predictions, the continue button 1830 may be used to proceed to the next portion of game play—creating chains.

FIG. 18B shows a chain 1855 created by a participant from a set of tiles for which that participant has made a prediction. As shown in interface 1850, a chain begins with a tile 1860, which has the lowest predicted value made by the participant. The participant can then select to add the next lowest predicted value to the chain or to create a new branch. In the example of FIG. 18B, the participant has created a branch 1865 with an upper branch with a single additional tile and a lower branch with three additional tiles. Again, the path for each branch is required to be in ascending order. As noted, until the close of a prediction cycle, a user may continue to rearrange the chain, as well as update prediction values.

FIG. 18C shows a chain “topple” following a prediction cycle. In this example, because the value of a second tile 1890 is lower than an initial tile 1885, the initial tile 1885 is toppled. However, the participant may restart the topple using a limited number of restart chances. In some cases, the “toppling” may restart automatically at a tile where the predicted value is within a specified margin of error to the actual value (e.g., +/−5%).

While the exemplary embodiments shown in FIG. 9-18 present a variety of user interfaces and game types for conducting market research using social network games, the interfaces illustrated in these Figures provide examples of an approach for conducting market research that could be adapted for a broad variety of market research subjects or topics, as well as adapted for a broad variety of game types or game play mechanics. This approach presents an engaging experience to game participants, while simultaneously allowing a market research sponsor to rapidly gather market research data. Advantageously, providing a more engaging experience in this manner may provide an element of situational distraction, leading to more authentic responses from the participants. Further, by providing games through social network websites (and applications used to access such online social networks), participants may be recruited by the users of such networks.

While the forgoing is directed to embodiments of the present disclosure, other and further embodiments of the disclosure may be devised without departing from the basic scope thereof. For example, aspects of the present disclosure may be implemented in hardware or software or in a combination of hardware and software. One embodiment of the disclosure may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the present disclosure, are embodiments of the present disclosure.

In view of the foregoing, the scope of the present disclosure is determined by the claims that follow.

We claim:

1. A computer implemented method of conducting market research using an online game played by a plurality of participants, the method comprising:
providing, to each of the plurality of participants, a set of prediction cards, wherein each prediction card specifies a measure for determining a point value of the prediction card based on a corresponding future event identified by the prediction, wherein the online game is configured to allow each participant to retain or discard each of the prediction cards;
providing, to the plurality of participants, a first interface for a first one of the participants to selectively trade prediction cards in the set of the first participant with a prediction card in the set of one the second participants; and
monitoring, by operation of a processor, (i) a count of how many times a respective prediction card is discarded by one of the participants and (ii) trades made by respective first and second participants.

2. The method of claim 1, further comprising:
determining, for a first prediction card, a point value for the first prediction card based on the measure and an occurrence of the corresponding future event; and
awarding, to each participant holding the first prediction card, the determined point value.

3. The method of claim 1, wherein monitoring trades made by respective first and second participants comprises determining a premium required for a trade which includes a first prediction card and a second prediction card to occur.

4. The method of claim 1, further comprising:
determining, a discard ratio as a ratio of the count of how many times the respective prediction card is discarded to a count of a number of hands retaining the respective prediction card.

5. The method of claim 4, further comprising:
presenting to the first and second participant, an interface for playing a plurality of rounds;
receiving, from each of the first and second participant, a selection of one of the prediction cards in their hand; and
determining, as a winner of the round, the player who selected the prediction card with a lower discard ratio.

6. A computer implemented method of conducting market research using an online game played by a first participant on a handheld device, the method comprising:
repeatedly:
selecting a cell in a grid of cells rendered on a display of the handheld device,
determining a current challenge to present to the first participant on the display, wherein the current challenge requests the first participant capture an image of a specified object, via a camera on the handheld device, and wherein the subject of at least one current challenge corresponds to a market research topic, and
receiving either (i) an indication from the participant to pass on the current challenge or (ii) the requested image to use to fill in the selected cell;
until either (i) a specified time period has elapsed or (ii) the first participant has filled in a specified configuration of cells in the grid.

7. The method of claim 6, further comprising:
presenting, to a second participant, one of the challenges presented to the first participant along with an image received from the first participant in response to the challenge; and
requesting that the second participant verify that the received image depicts the specified object.

8. The method of claim 6, wherein the first participant incurs a time penalty for passing on the current challenge.

9. The method of claim 6, further comprising, upon determining the first participant has filled in the specified configuration of cells in the grid, rewarding the first participant with a predetermined reward.

10. A computer implemented method of conducting market research using an online game played by a first participant and a second participant, the method comprising:
presenting a prediction question to the first participant, wherein the prediction question is associated with a game play card in the online game, and wherein the prediction question corresponds to a first market research topic;
presenting the prediction question to the second participant;
receiving, from the first and second participants, an estimate of an answer to the prediction question;
providing, to the first and second participants, a plurality of game play cards, wherein each card poses a statistical question having a known value, and wherein the question posed by one or more of the game play cards corresponds to a second market research topic; and
presenting, by operation of a processor, a respective game play interface to the first and second participant, wherein the first and second participants each play one of the game play cards during each of a set number of rounds via the respective interfaces.

11. The method of claim 10, wherein a winner of a given round is determined relative to the known value of the game play cards played by the first and second participants in the given round.

12. The method of claim 10, wherein the estimate of the answer provided by the first and second participants is used to assign a value to the game play card corresponding to prediction for purposes of game play.

13. The method of claim 10, further comprising:
determining, for the first market research topic, a crowd-sourced opinion related to the first market research topic from a plurality of estimates to the answer of the prediction question provided by participations playing the online game.

14. A computer implemented method of conducting market research using an online game played by a first participant, the method comprising:
during a first time period:
receiving, from the first participant, a selection of a plurality of tiles, wherein each tile presents a question related to an event that will occur during a second time period, and wherein the selection includes an estimated answer of the question posed by each selected tile, and wherein one or more of the questions correspond to a respective market research topic, and
receiving, from the first participant, an arrangement of the selected tiles, wherein the arrangement orders the selected one or more tiles in a connected chain having an ascending order, beginning from a tile having a lowest estimated value; and
following the second time period:
replacing, the estimated value in each tile with an actual value for each of the event presented in each selected tile,
beginning from the tile having the lowest estimated value, toppling subsequent tiles in the connected chain until encountering a subsequent tile having an actual value that is not in ascending order, and
awarding a score to the first participant based on a length of the toppled tiles in the connected chain.

15. The method of claim 14, wherein the connected chain includes one or more branch points, wherein each path created by the branch point orders a set of tiles on that path in an ascending order.

16. The method of claim 14, further comprising, following the second time period, restarting toppling subsequent tiles at a tile in the connected chain having an estimated value within a specified margin of error relative to the actual value.

17. A computer-readable storage medium storing code for execution by a processor, wherein the code, when executed, performs an operation for conducting market research using an online game played by a plurality of participants, the operation comprising:
providing, to each of the plurality of participants, a set of prediction cards, wherein each prediction card specifies a measure for determining a point value of the prediction card based on a corresponding future event identified by the prediction, wherein the online game is configured to allow each participant to select to retain or discard each of the prediction cards;
providing, to the plurality of participants, a first interface for a first one of the participants to selectively trade prediction cards in the set of the first participant with a prediction card in the set of one the second participants; and
monitoring, by operation of a processor, (i) a count of how many times a respective prediction card is discarded by one of the participants, and (ii) trades made by respective first and second participants.

18. The computer-readable storage medium of claim 17, wherein the operation further comprises:
determining, for a first prediction card, a point value for the first prediction card based on the measure and an occurrence of the corresponding future event; and
awarding, to each participant holding the first prediction card, the determined point value.

19. The computer-readable storage medium of claim 17, wherein monitoring trades made by respective first and second participants comprises determining a premium required for a trade which includes a first prediction card and a second prediction card to occur.

20. The computer-readable storage medium of claim 17, wherein the operation further comprises:
determining, a discard ratio as a ratio of the count of how many times the respective prediction card is discarded to a count of a number of hands retaining the respective prediction card.

21. The computer-readable storage medium of claim 20, wherein the operation further comprises:
presenting to the first and second participant, an interface for playing a plurality of rounds;
receiving, from each of the first and second participant, a selection of one of the prediction cards in their hand; and
determining, as a winner of the round, the player who selected the prediction card with a lower discard ratio.

22. A computer-readable storage medium storing code for execution by a processor, wherein the code, when executed, performs an operation for conducting market research using an online game played by a first participant on a handheld device, the operation comprising:
repeatedly:
selecting a cell in a grid of cells rendered on a display of the handheld device,
determining a current challenge to present to the first participant on the display, wherein the current challenge requests the first participant capture an image of a specified object, via a camera on the handheld device, and wherein the subject of at least one current challenge corresponds to a market research topic, and
receiving either (i) an indication from the participant to pass on the current challenge or (ii) the requested image to use to fill in the selected cell;
until either (i) a specified time period has elapsed or (ii) the first participant has filled in a specified configuration of cells in the grid.

23. The method of claim 22, wherein the operation further comprises:
presenting, to a second participant, one of the challenges presented to the first participant along with an image received from the first participant in response to the challenge, and
requesting that the second participant verify that the received image depicts the specified object.

24. The method of claim 22, wherein the first participant incurs a time penalty for passing on the current challenge.

25. The method of claim 22, wherein the operation further comprises, upon determining the first participant has filled in the specified configuration of cells in the grid, rewarding the first participant with a predetermined reward.

26. A computer-readable storage medium storing code for execution by a processor, wherein the code, when executed, performs an operation for conducting market research using an online game played by a first participant and a second participant, the operation comprising:
presenting a prediction question to the first participant, wherein the prediction question is associated with a game play card in the online game and wherein the prediction question corresponds to a first market research topic;
presenting the prediction question to the second participant;
receiving, from the first and second participants, an estimate of an answer to the prediction question;
providing, to the first and second participants, a plurality of game play cards, wherein each card poses a statistical question having a known value, and wherein the question posed by one or more of the game play cards corresponds to a second market research topic; and
presenting, by operation of a processor, a respective game play interface to the first and second participant, wherein the first and second participants each play one of the game play cards during each of a set number of rounds via the respective interfaces.

27. The computer-readable storage medium of claim 26, wherein a winner of a given round is determined relative to the known value of the game play cards played by the first and second participants in the given round.

28. The computer-readable storage medium of claim 26, wherein the estimate of the answer provided by the first and second participants is used to assign a value to the game play card corresponding to prediction for purposes of game play.

29. The computer-readable storage medium of claim 26, wherein the operation further comprises:
determining, for the first market research topic, a crowd-sourced opinion related to the first market research topic from a plurality of estimates to the answer of the prediction question provided by participations playing the online game.

30. A computer-readable storage medium storing code for execution by a processor, wherein the code, when executed, performs an operation for conducting market research using an online game played by a first participant, the operation comprising:
during a first time period:
receiving, from the first participant, a selection of a plurality of tiles, wherein each tile presents a question related to an event that will occur during a second time period and wherein the selection includes an estimated answer of the question posed by each selected tile, and wherein one or more of the questions correspond to a respective market research topic, and
receiving, from the first participant, an arrangement of the selected tiles, wherein the arrangement orders the selected one or more tiles in a connected chain having an ascending order, beginning from a tile having a lowest estimated value; and
following the second time period:
replacing, the estimated value in each tile with an actual value for each of the event presented in each selected tile,
beginning from the tile having the lowest estimated value, toppling subsequent tiles in the connected chain until encountering a subsequent tile having an actual value that is not in ascending order, and
awarding a score to the first participant based on a length of the toppled tiles in the connected chain.

31. The computer-readable storage medium of claim 30, wherein the connected chain includes one or more branch points, wherein each path created by the branch point orders a set of tiles on that path in an ascending order.

32. The computer-readable storage medium of claim 30, further comprising, following the second time period, restarting toppling subsequent tiles at a tile in the connected chain having an estimated value within a specified margin of error relative to the actual value.
